(19) United States
(12) Patent Application Publication
(10) Pub. No.: US 2025/0170610 A1
(43) Pub. Date: May 29, 2025

(54) PROCESS FOR APPLYING COATING COMPOSITIONS HAVING DIFFERENT LEVELING PROPERTIES AND/OR SAG RESISTANCE TO DIFFERENT TARGET AREAS OF AN OBJECT

(71) Applicant: BASF COATINGS GMBH, Muenster (DE)

(72) Inventors: Christian BECKHAUS, Muenster (DE); Matthijs GROENEWOLT, Muenster (DE); Georg WIGGER, Muenster (DE); Britta BUEKER, Muenster (DE)

(21) Appl. No.: 18/839,888

(22) PCT Filed: Mar. 16, 2023
(86) PCT No.: PCT/EP2023/056728

§ 371 Date: Aug. 20, 2024

(30) Foreign Application Priority Data
Mar. 23, 2022 (EP) 22163697.0

(51) Int. Cl. B05D 7/00; B05C 5/02; B05D 1/02; B05D 5/06

(52) U.S. Cl. CPC B05D 7/572; B05C 5/02; B05D 1/02; B05D 5/061; B05D 2502/005

(57) ABSTRACT

Described herein is a process for applying at least two coating compositions having different leveling properties and/or a different sag resistance to an object including a plurality of target areas where at least part of the plurality of target areas has different properties. Also described herein are a method of using the inventive process for coating target areas of an object having different orientations relative to each other and a system for applying—utilizing an application device—at least two coating compositions having different leveling properties and/or a different sag resistance to an object including a plurality of target areas, where at least part of the plurality of target areas having different properties.

The present invention relates to a process for applying at least two coating compositions having different leveling properties and/or a different sag resistance to an object comprising a plurality of target areas wherein at least part of the plurality of target areas has different properties. The coating compositions are applied such that each coating composition is not applied to target area(s) having different properties, i.e. target area(s) having the same property are coated with the same coating composition having specific leveling properties and/or a specific sag resistance. The inventive process allows to match the leveling properties and/or sag resistance of the coating composition to the leveling properties and/or the sag resistance required with respect to the properties of the different target area(s). This allows to coat areas of an object having different orientations relative to each other in a high quality because the leveling properties and/or sag resistance of the coating composition required for target areas having different orientations can be matched to the orientation of the target area(s). Furthermore, the present invention relates to the use of the inventive process for coating target areas of an object having different orientations relative to each other. Finally, the present invention relates to a system for applying—utilizing an application device—at least two coating compositions having different leveling properties and/or a different sag resistance to an object comprising a plurality of target areas, wherein at least part of the plurality of target areas having different properties.

### PRIOR ART

In the painting of high-quality goods, for example automobiles, the paint is usually applied in multiple layers. In multilayer paint systems of this kind for automobile chassis, a primer is first applied, which is intended to improve the adhesion between the substrate and the subsequent layers, and also serves to protect the substrate from corrosion if it is prone to corrosion. In addition, the primer ensures an improvement in the surface characteristics, by covering over any roughness and structure present in the substrate. Especially in the case of metal substrates, a primer-surfacer is often applied to the primer, the task of which is to further improve the surface characteristics and to improve the resistance to stonechipping. Typically, one or more coloring and/or effect layers are applied to the primer-surfacer, which are referred to as the basecoat. Finally, a clearcoat is generally applied to the basecoat, which ensures the desired shiny appearance and protects the paint system from environmental effects. Combinations of a basecoat with a clearcoat are also referred to as composite color-plus-clear coatings.

Color-plus-clear systems are often selected when an exterior coating must possess an optimum visual appearance as well as superior durability and weatherability. As a result, the automotive industry has made extensive use of color-plus-clear composite coatings, especially for automotive body panels. Minimum performance requirements for clearcoat coating compositions intended for use on automotive body panels include high levels of adhesion, scratch and mar resistance, chip resistance, humidity resistance, and weatherability as measured by QUV and the like. The clearcoat composition must also be capable of providing a visual appearance characterized by a high degree of gloss, distinctness of image (DOI), and smoothness. Finally, such coatings must also be easy to apply in a manufacturing environment and be resistant to application defects.

Clearcoats used in color-plus-clear systems are normally applied at film builds significantly higher than the film builds at which the colored basecoat is applied. Such higher clearcoat film builds are an aspect of the system that contributes toward the desired appearance and/or durability of the overall color-plus-clear system. For example, automotive original equipment manufacturing (OEM) facilities typically apply clearcoat compositions at wet film builds of from 20.3 to 152.4 μm (0.8 to 6.0 mils) to provide cured clearcoat film builds of from 12.7 to 88.9 μm (0.5 to 3.5 mils). In contrast, the colored basecoat compositions are usually applied at wet film builds of from 5.1 to 101.6 μm (0.2 to 4.0 mils) to provide cured basecoat film builds of from 2.5 to 50.8 μm (0.1 to 2.0 mils).

Unfortunately, the higher film build requirement for clearcoats can exacerbate the tendency of a clearcoat composition to sag. Occurring primarily on vertically orientated surfaces, sag may be described as the undesirable downward flow of an applied coating. Often manifesting as drips or runs, sag is sometimes attributed to the “too heavy” or “too wet” application of a coating. Ideally, a commercially successful clearcoat composition will have an inherent tendency to resist sagging regardless of application and/or facility parameters. The more resistant a clearcoat is to sagging on vertically orientated surfaces, the easier it will be to apply in an automotive OEM facility.

However, a clearcoat resistant to vertically orientated sagging has traditionally shown increased resistance to flow on horizontally orientated surfaces. A coating composition's resistance to flow on horizontally orientated surfaces often results in “orange peel” and/or an overall unacceptable appearance in terms of the smoothness, gloss and DOI of the resulting cured film. Orange peel may be described as a reoccurring irregularity in the surface of a cured film resulting from the inability of an applied wet film to “level out” after application. Although an orange peeled cured film may feel smooth to the touch, it appears as a continuous series of small bumps or dimples. The greater the inability of an applied wet film to “level out” or flow, the more pronounced or defined the small bumps or dimples will appear to the observer. The presence of such surface irregularities make it particularly difficult to obtain a smooth, glossy coated clearcoated surface having a high DOI rating.

Clearly, sufficient leveling and minimization of sagging are conflicting requirements. One approach to obtain a sufficient overall appearance is to carefully control the rheological properties of paints to ensure that the paint obtains the proper value of the total film flow giving a good balance between sagging and leveling. This approach is currently used in the automotive manufacturing industry (also called OEM hereinafter), where only one clearcoat quality having a good balance between sagging and leveling is applied on horizontal as well as vertical areas of the automotive. While the use of said clearcoat quality results in sufficient overall appearance, the quality on horizontal areas cannot be increased without simultaneously decreasing the quality on vertical areas and vice versa as described previously.

It would be advantageous to apply different coating materials having leveling properties and/or a sag resistance which is customized on the orientation of the part of the object to be coated, as then leveling and sagging could be optimized independent of each other to achieve a higher quality in terms of overall appearance of the resulting coated object. The applied coating materials having customizable leveling properties and/or sag resistance should be easy to formulate from a limited number of components and should be suitable for use in combination with conventional application equipment. Moreover, the tuned coating compositions should allow a more efficient usage in terms of material consumption because their properties are tuned for the respective application, thus rendering application of higher amounts of an untuned coating composition to achieve the same result superfluous.

### Object

Therefore, an object of the present invention is to provide a process for applying at least two coating compositions having different leveling properties and/or a different sag resistance to different target areas of an object. Said process should allow to match the leveling properties and/or the sag resistance of the coating compositions to the properties, such as the orientation, of the target area of the object to improve the overall appearance of the resulting coating layer. Application of coating compositions having leveling properties and/or a sag resistance tuned to the properties of the respective target area of the object should result in lower consumption of the coating compositions, thus rendering the process more efficient and reducing generation of volatile organics during curing of the applied coating materials. The process should allow to use commonly used application equipment and should result in coating layers having good optical and mechanical properties.

### Technical Solution

This problem is solved by the subject matter claimed in the claims and also by the preferred embodiments of that subject matter as described hereinafter.

A first subject of the present invention is therefore a process for applying at least two coating compositions having different leveling properties and/or a different sag resistance to an object comprising at least two target areas, each target area having different properties, said process comprising:
(a) providing a first coating composition C₁ having specific leveling properties and/or a specific sag,
(b) applying the first coating composition C₁ provided in step (a) onto at least part of the target areas having first properties P₁, and
(c) repeating steps (a) and (b) at least once, wherein
the specific leveling properties and/or a specific sag resistance of each further coating composition Cₓ provided upon repeating step (a) differ from the specific leveling properties and/or the specific sag resistance of the previously provided coating composition P₁ and each previously provided further coating composition Cₓ, and
each coating composition Cₓ is applied onto at least part of the target areas having properties being different from the properties P1 and the properties of each further previously coated target areas upon repeating step (b).

The above-specified process is hereinafter also referred to as process of the invention and accordingly is a subject of the present invention. Preferred embodiments of the process of the invention are apparent from the description hereinafter and also from the dependent claims.

The inventive process allows to match the specific leveling properties and/or sag resistance of coating compositions to the respective property of the target area of the object. For example, highly rheology modified coating compositions, i.e. coating compositions having a high sag resistance, are applied on vertically oriented target areas of the object to avoid sagging of the applied coating composition which would result in a negative influence on the overall optical appearance of the coated object. On horizontally oriented target areas, low rheology modified coating compositions are applied to obtain good leveling on these target areas, thus avoiding a negative influence associated with low leveling on the overall optical appearance of the coated object. The use of a coating composition having better leveling properties on horizontally oriented target areas as compared to a coating composition having balanced leveling properties and sag resistance is achieved at lower layer thicknesses, so that a lower amount of coating composition can be applied onto these target areas. Matching of the properties of the coating compositions to the different properties of the target areas of the object within the inventive process results in a higher overall optical quality and usage of lower amounts of coating composition as compared to the use of a single coating composition having balanced leveling properties and sag resistance because the leveling properties and/or the sag resistance of each coating composition applied in step (b) are tuned to the respective property of the target area of the object, in particular to the orientation of the target area of the object.

A further subject of the present invention is a process for applying at least two clearcoat coating compositions having different leveling properties and/or a different sag resistance to an object comprising a plurality of target areas, at least part of the plurality of target areas having different properties, said process comprising:
(a) providing a first clearcoat coating composition C₁ having a high sag resistance and a further clearcoat composition Cₓ having high leveling properties,
(b) applying the first clearcoat coating composition C₁ provided in step (a) onto at least part of the plurality of vertically oriented target areas,
(c) applying the further clearcoat coating composition Cₓ provided in step (a) onto at least part of the plurality of horizontally oriented target areas, and
(d) optionally repeating step (b) or repeating steps (b) and (c) at least once.

A further subject of the present invention is the use of the inventive process for coating areas of an object having different orientations relative to each other.

A further subject of the present invention is a system for applying—utilizing an application device—at least two coating compositions having different leveling properties and/or a different sag resistance to an object comprising at least two target areas, each target area having different properties, the system comprising:
an application device comprising an applicator comprising a nozzle;
a storage device for storing application instructions and optionally mixing ratio instructions;
one or more data processors configured to execute the application instructions and optionally the mixing ratio instructions to control the application device; and
at least two reservoirs in fluid communication with the applicator and configured to contain at least two components (Aᵢ)_{i=1, . . . , n}, each component Aᵢ having different leveling properties and/or a different specific sag resistance, and optionally at least one hardener component B or configured to contain at least two coating compositions (Cᵢ)_{i=1, . . . , n} having specific leveling properties and/or a specific sag resistance,
wherein the applicator is configured to
   receive the components (Aᵢ)_{i=1, . . . , n} and optionally the hardener component B from the reservoir and to mix the components (Aᵢ)_{i=1, . . . , n}, optionally with the hardener component B, based on the mixing ratio instructions within the nozzle, and
   to expel the resulting coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object; or
wherein the applicator is configured to
   receive the at least two coating compositions (Cᵢ)_{i=1, . . . , n} from the reservoir, and
   to expel the coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object.

A further subject matter of the present invention is a system for applying—utilizing an application device—at least two clearcoat coating compositions having different leveling properties and/or a different sag resistance to an object comprising a plurality of target areas, at least part of the plurality of target areas having different properties, the system comprising:
an application device comprising a nozzle;
a storage device for storing application instructions and optionally mixing ratio instructions;
one or more data processors configured to execute the application instructions and optionally the mixing ratio instructions to control the application device; and
two reservoirs in fluid communication with the application device and configured to contain two components (Cᵢ)_{i=1, . . . , n}, each component Aᵢ having different leveling properties and a different specific sag resistance, and optionally at least one hardener component B or configured to contain two coating compositions (Cᵢ)_{i=1, . . . , n}, one clearcoat coating composition having high leveling properties and the second clearcoat composition having a high sag resistance,
wherein the application device is configured to
   receive the components (Aᵢ)_{i=1, . . . , n} and optionally the hardener component B from the reservoir and to mix the components (Aᵢ)_{i=1, . . . , n}, optionally with the hardener component B based on the mixing ratio instructions within the nozzle, and
   to firstly expel the resulting first clearcoat coating compositions (C₁) based on the application instruction through the nozzle to vertically oriented target areas and to secondly expel the resulting second clearcoat coating compositions (C₂) based on the application instruction through the nozzle to horizontally oriented target areas to form two coating layers; or
wherein the applicator is configured to
   receive the two coating compositions (Cᵢ)_{i=1, . . . , n} from the reservoir, and
   to firstly expel the first clearcoat coating compositions (C₁) based on the application instruction through the nozzle to vertically oriented target areas and to secondly expel the resulting second clearcoat coating compositions (C₂) based on the application instruction through the nozzle to horizontally oriented target areas to form at least two coating layers.

### DETAILED DESCRIPTION

### Definitions

First of all, a number of terms used in the context of the present invention will be explained.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In this description of the invention, for convenience, “polymer” and “resin” are used interchangeably to encompass resins, oligomers, and polymers.

The term “poly(meth)acrylate” stands both for polyacrylates and for polymethacrylates. Poly(meth)acrylates may therefore be constructed of acrylates and/or methacrylates and may contain further ethylenically unsaturated monomers such as, for example, styrene or acrylic acid. The term “(meth)acryloyl” respectively, in the sense of the present invention embraces methacryloyl compounds, acryloyl compounds and mixtures thereof.

The term “leveling properties” refers to the ability of a coating material to eliminate surface defects that occur after the application of said coating material. Said surface defects often cannot be seen immediately after application and may include orange peeling, craters, fisheyes, crawling and/or pinholes. Most of these defects are the result of local surface tension differences of the involved raw materials, of substrate contaminants or of surface tension differences as the result from solvent evaporation.

The term “sag resistance” is defined as the ability of an applied coating film to resist sagging failure, which is a bending or drooping of the wet coating due to gravitational forces. Sagging is a factor of the coating's composition and viscosity since a coating composition with a high viscosity results in a coating film having a greater sag resistance than a coating film produced form a coating composition having a low viscosity. The sag resistance can, for example, be determined in accordance with the ASTM D4400—Standard Test Method for Sag Resistance of Paints Using a Multinotch Applicator. The sag resistance can be influenced by use of a sagging control additive which influences, in particular increases, the sag resistance of a coating film produced from the respective component or coating material.

The term “plurality of target areas” refers to at least two target areas being present on the object to be coated. A target area is a defined area, i.e. an area having defined dimensions, on the object onto which a coating composition is to be applied. The term “at least part of the plurality of target areas having different properties” means, in the sense of the present invention, that at least two target areas of the plurality of target areas have different properties. Thus, either all target areas present on the object have different properties, i.e. the properties of each target area differ from the properties of each further target area or some target areas have the same properties while other target area(s) have different properties. The term “properties” refers to either a single property or a number of properties.

The term “applying the coating composition onto at least part of the plurality of target areas having properties X” refers to an application process in which the coating composition is not necessarily applied onto all target areas having property X and being present on the object. Thus, for example, if the object contains 8 target areas including 4 vertically oriented target areas and 4 horizontally oriented target areas, the coating composition can be applied to 1, 2, 3 or all 4 vertically oriented target areas or to 1, 2, 3 or all 4 horizontally oriented target areas. Application of a coating composition to a defined target area or to more than one defined target area does, however, not exclude that some parts of adjacent target areas having different properties are unintentionally coated with said coating composition because of occurring overspray effects. However, the same coating composition is not intentionally applied onto target areas having different properties.

The term “the specific leveling properties and/or a specific sag resistance of each further coating composition Cₓ provided upon repeating step (a) differ from the specific leveling properties and/or the specific sag resistance of the previously provided coating composition P₁ and each previously provided further coating composition Cₓ” means within the sense of the present invention that each coating composition P₁ provided upon performing step (a) or each coating composition Cₓ provided upon repeating step (a) differs in the leveling properties and/or the sag resistance. Thus, step (a) does not embrace provision of two coating compositions having identical leveling properties and/or an identical sag resistance.

The term “applying each coating composition Cₓ onto at least part of the plurality of target areas having properties being different from the properties P₁ and the properties of each further previously coated target areas” refers to an application process in which the same coating composition is not applied onto at least two target areas having different properties. Thus, each coating composition having specific leveling properties and/or a specific sag resistance is assigned to target area(s) having specific properties and is only applied on said target area(s). All assigned target areas may be coated at once or in several steps.

The term “specific leveling properties and/or specific sag resistance of a coating composition” refers to the leveling properties and/or the sag resistance associated with said coating composition, i.e. the leveling properties and/or the sag resistance which are due to the composition of the coating composition, such as for example, due to the presence or absence of sagging control agents (SCAs).

A “hardener component” in the context of the present invention is a material comprising at least one crosslinking component being capable of reacting with functional chemical groups being present with at least one compound contained in at least one component provided in step (a) of the inventive process, for example at least one binder. Reaction of the crosslinking component with the binder being present in at least one component provided in step (a) results in the formation of a network structure upon curing of the applied coating composition.

“Binder” in the context of the present invention and in accordance with DIN EN ISO 4618:2007-03 is the nonvolatile component of a coating composition, without pigments and fillers. Hereinafter, however, the expression is used principally in relation to particular physically and/or chemically curable polymers, examples being polyurethanes, polyesters, polyethers, polyureas, polyacrylates, polysiloxanes and/or copolymers of the stated polymers. The nonvolatile fraction may be determined according to DIN EN ISO 3251: 2018-07 at 130° C. for 60 min using a starting weight of 1.0 g.

As used herein, the term “water-based coating composition” refers to a coating composition which comprises a water fraction of at least 20 wt. %, preferably at least 25 wt. %, very preferably at least 50 wt. %, based in each case on the total weight of the coating composition. The water fraction is preferably 40 to 60 wt. %, more particularly 45 to 70 wt. %, very preferably 50 to 80 wt. %, based in each case on the total weight of the coating composition. In contrast, the term “solvent-based coating composition” refers to a coating composition with comprises a fraction of organic solvents of at least 20 wt. %, preferably at least 25 wt. %, very preferably at least 45 wt. %, based in each case on the total weight of the coating composition. The organic solvent fraction is preferably 40 to 70 wt. %, more particularly 45 to 65 wt. %, very preferably 50 to 60 wt. %, based in each case on the total weight of the coating composition.

“Vertically orientated” as used herein refers to surfaces which are substantially parallel to the direction of gravity, i.e., at an angle of 90°±45° relative to the surface of the earth, more preferably at an angle of 90°±30° relative to the surface of the earth. “Horizontally orientated” refers to surfaces which are substantially perpendicular to the direction of gravity, i.e., at an angle of 180°±45° relative to the surface of the earth, more preferably at an angle of 180°±30° relative to the surface of the earth.

As used herein, the term “drying” of the applied coating composition refers to the evaporation of solvents from the applied coating composition. Drying can be performed at ambient temperature or by use of elevated temperatures. However, the drying does not result in a coating film being ready for use, i.e. a cured coating film as described below, because the coating film is still soft or tacky after drying. Accordingly, “curing” of the applied coating composition or the coating film resulting from drying the applied coating composition refers to the conversion of such a composition or film into the ready-to-use state, i.e. into a state in which the object provided with the respective coating layer can be transported, stored and used as intended. More particularly, a cured coating layer is no longer soft or tacky, but has been conditioned as a solid coating layer which does not undergo any further significant change in its properties, such as hardness or adhesion to the object, even under further exposure to curing conditions. Curing can be performed at higher temperatures and/or for longer times than used for drying of the applied coating composition.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the object or the coated object is located. It does not mean, therefore, that the object itself is required to have the temperature in question.

### Inventive Process:

The process of this invention allows to apply at least two coating compositions having different leveling properties and/or a different sag resistance onto an object comprising at least two target areas having different properties, preferably having a different orientation relative to each other, such that the same coating composition, i.e. each coating composition having specific leveling properties and/or a specific sag resistance, is assigned to and applied onto target areas having the same properties. This allows to apply a coating composition having specific leveling properties and/or a specific sag resistance to the target area of the object having matching properties, such as for example an orientation matching the specific leveling properties and/or the specific sag resistance of the respective coating composition. Matching of the properties of the target area(s) to the leveling properties and/or the sag resistance of the coating composition(s) allows to obtain an improved overall visual appearance of the resulting coated object as well as reduced material consumption.

According to a preferred embodiment of the process, the different properties include different orientations of at least two target areas relative to each other. In one example, each target area of the plurality of target areas has different properties with respect to the other target areas present on the object. In another example, the object comprises a plurality of target areas, wherein part of the plurality of target areas have the same properties, while the remaining part of the plurality of target areas have different properties.

### Step (a):

In step (a) of the inventive process, either a first coating composition C₁ having specific leveling properties and/or a specific sag resistance is provided (in case step (a) is performed for the first time) or at least one further coating composition Cₓ having specific leveling properties and/or a specific sag resistance being different from each previously provided coating composition C₁ and Cₓ is provided (in case step (a) is repeated at least once—see step (c) below).

The first coating composition C₁ and the at least one further coating composition Cₓ can be provided in step (a) in a number of ways. According to a first embodiment of step (a), providing the first coating composition C₁ and/or at least one further coating compositions Cₓ includes
(a-1) providing at least two components (Aᵢ)_{i=1, . . . , n} having different leveling properties and/or a different sag resistance and optionally at least one hardener component B,
(a-2) selecting mixing ratios for at least part of the components Aᵢ provided in step (a-1) to achieve specific leveling properties and/or a specific sag resistance of the first coating composition C₁ and/or further coating composition(s) Cₓ,
(a-3) optionally selecting mixing ratio(s) for the at least one hardener component B provided in step (a-1), and
(a-4) mixing components Aᵢ, optionally with at least one hardener component B in the mixing ratios selected in step (a-2) and optionally (a-3) to provide the first coating composition C₁ and/or further coating composition(s) Cₓ having specific leveling properties and/or a specific sag resistance.

The term “(Aᵢ)_{i=1, . . . , n}” denotes a sequence of components Aᵢ such as, for example A₁, A₂, A₃, . . . , Aₙ with n being the last member of the sequence. The term “component” refers to a single ingredient or a mixture of at least two ingredients.

Providing the coating composition(s) C₁ and/or Cₓ according to the first embodiment may be preferred if the leveling properties and/or the sag resistance of the components (Aᵢ)_{i=1, . . . , n} provided in step (a-1) is/are not matching the different properties of the target areas. This may be the case if the components provided in step (a-1) have leveling properties and/or a sagging resistance which is too high/low compared to the leveling properties and/or the sag resistance required to match the properties of the respective target areas, such as the orientation of the respective target areas. To prepare coating compositions having leveling properties and/or a sag resistance matched to the properties of the respective target areas, at least part of the components provided in step (a-1) have to be mixed.

In step (a-2), a mixing ratio for at least part of the components provided in step (a-1) is selected such that specific leveling properties and/or a specific sag resistance of the first coating composition C₁ and/or further coating composition(s) Cₓ is/are achieved. The specific leveling properties and/or the specific sag resistance can be predefined leveling properties/a predefined resistance and may depend, for example, on the orientation of the target areas the respective coating compositions C₁ and Cₓ are intended to be applied in step (b).

Step (a-2) may include determining the required specific leveling properties and/or the required specific sag resistance of the first coating composition C₁ and/or further coating composition(s) Cₓ and selecting a mixing ratio for at least part of the components provided in step (a-1) such that the specific leveling properties and/or the specific sag resistance of the resulting first coating composition C₁ and/or further coating composition(s) Cₓ is achieved. Determining the specific leveling properties and/or sag resistance may include determining the orientation of the target area(s) of the object to be coated with said coating composition in step (b) and selecting a mixing ratio resulting in specific leveling properties and/or a specific sag resistance being appropriate for the determined orientation. In one example, mixing ratios may be interrelated with components Aᵢ and orientations of the target area(s) and may be provided to the user performing the process in paper form or in electronic form. In another example, mixing ratios may be interrelated with components Aᵢ and orientations of the target area(s) and may be stored in a database. A processing device having access to the database may determine appropriate mixing ratio(s) upon providing the determined orientation of the target area(s) and an indication of the components Aᵢ (such as the formulation, a number being indicative of the components of components Aᵢ, etc.) to the processing device and display the determined mixing ratio(s) to the user or provide the determined mixing ratio to a mixing device to automatically mix the coating composition(s) based on the provided mixing ratio(s) and data on components Aᵢ.

In one example, a higher fraction of components provided in step (a-1) and having a high sag resistance is selected in step (a-2) if a higher sag resistance of the first coating composition C₁ and/or further coating composition(s) Cₓ is required. In another example, a lower fraction of components provided in step (a-1) and having a high sag resistance is selected in step (a-2) if higher leveling properties of the first coating composition C₁ and/or further coating composition(s) Cₓ are required. This allows to tune the leveling properties and/or the sag resistance of the resulting coating composition(s) C₁ and/or Cₓ to the respective properties, such as the orientation, of the different target areas by selecting an appropriate mixing ratio between the at least two components provided in step (a-1). This allows to vary the rheology modification of the coating composition depending on the respective needs for the application in step (b) and allows, for example, to adjust the rheology of the coating material depending on the orientation of the target area(s) to be coated in step (b). The variation of the mixing ratio to achieve the desired leveling properties and/or sag resistance of the coating composition allows to obtain a large number of coating compositions having defined leveling properties and/or sag resistance by providing only two components in step (a-1), namely a component comprising a binder and a component comprising a rheology modifier. This allows to reduce the number of coating compositions which need to be stored to achieve comparative results in terms of appearance, thus reducing the need for extensive storage capacities.

In one example of the first embodiment of step (a), the at least one component Aᵢ provided in step (a-1) comprises at least one binder. With particular preference, each component (A₁, . . . , Aₙ) provided in step (a-1) comprises at least one binder.

The at least one binder present in each provided component Aᵢ may be identical to at least one binder being present in the other provided components Aₙ₋ᵢ or the at least one binder being present in each provided component Aᵢ may be different from the binder(s) present in the other provided components Aₙ₋ᵢ. It may be beneficial if each component Aᵢ comprises at least one identical binder, i.e. each provided component Aᵢ contains at least one binder being identical to the binder(s) present in the other provided components Aₙ₋ᵢ. This increases the compatibility upon mixing of the provided components (A₁, . . . , Aₙ) in step (a-4) and thus reduces the occurrence of unwanted incompatibilities having a negative influence on the resulting overall appearance of the coating layer resulting from step (b) or the application of the resulting coating composition(s) C₁ and/or Cₓ in step (b). Suitable binders and total amounts of binders are the binders and total amounts described later on in relation to the coating compositions C₁ and Cₓ.

The mixing ratios selected in step (a-2) and optional step (a-3) are preferably by volume. With preference, a volume:volume mixing ratio for the mixture of components Aᵢ and the at least one hardener component B of 8:1 to 1:1, preferably of 4:1 to 1:1 is selected in step (a-3). In case more than one hardener component B is provided in step (a-1), the aforementioned mixing ratios are valid for each hardener component provided in step (a-1). Use of these mixing ratios ensures a sufficient hardening of the resulting coating composition after application to the respective target area(s), thus avoiding a negative influence on the overall optical appearance due to insufficient hardening of the formed coating layer.

According to a second alternative of step (a), providing the first coating composition C₁ and/or at least one further the coating compositions Cₓ includes preparing the first coating composition C₁ and/or further coating composition(s) Cₓ having specific leveling properties and/or a specific sag resistance by mixing at least two coating material ingredients. The term “coating material ingredients” refers to compounds commonly used to prepare coating materials, such as solvents, pigments, binders, additives, etc. The specific leveling properties and/or the specific sag resistance can be obtained by using commonly known leveling additives or sagging control agents (SCAs) during the preparation of the coating composition(s) C₁ and/or Cₓ.

In one example, the first composition C₁ and/or further coating composition(s) Cₓ are each prepared by mixing at least one base component BCᵢ having specific leveling properties and/or a specific sag resistance with at least one hardener component B.

The at least one base component BCᵢ may be mixed with the at least one hardener component B in a volume:volume mixing ratio of 8:1 to 1:1, preferably of 4:1 to 1:1. Use of the hardener component B during preparation of the coating compositions C₁ and Cₓ is generally optional and is only necessary if said coating compositions are 2K coating compositions being prepared from a base component (i.e. the mixture resulting from mixing the components (A₁, . . . , Aₙ) provided in step (a-1) or the base component BCᵢ) and at least one hardener component B. In 2K coating compositions, the components (A₁, . . . , Aₙ) provided in step (a-1) or the base components BCᵢ contain binder(s) having functional groups which are not self-reactive, or the amount/type of crosslinking agent(s) contained in the provided components (A₁, . . . , Aₙ) or the base components BCᵢ is too low to achieve sufficient crosslinking during curing of the applied coating composition.

The hardener component B preferably comprises at least one crosslinking agent being capable of reacting with functional groups of a compound being present in at least one component Aᵢ provided in step (a-1) or in at least one base component BCᵢ.

In the case where the functional group of the binder is active hydrogen, particularly OH, the curing agent can be an aminoplast or polyisocyanate with the polyisocyanate being preferred. Suitable polyisocyanates include organic polyisocyanates containing aliphatically, cyclo-aliphatically, araliphatically and/or aromatically bonded free isocyanate groups. Preference is given to using polyisocyanates having from 2 to 5 isocyanate groups per molecule and having viscosities of from 100 to 10,000 mPa*s, preferably from 100 to 5,000 mPa*s and in particular from 100 to 2,000 mPa*s (at 23° C.). Where appropriate, small amounts of organic solvent, preferably from 1 to 25 wt.-% based on straight polyisocyanate, may be added to the polyisocyanates in order to improve the ease of incorporation of the polyisocyanate and, where appropriate, to lower the viscosity of the polyisocyanate to a level within the aforementioned ranges. Examples of suitable solvent additives to the polyisocyanates include ethoxyethyl propionate, amyl methyl ketone, and butyl acetate. Moreover, the polyisocyanates may have been given a conventional hydrophilic or hydrophobic modification. Further examples of suitable polyisocyanates are polyisocyanates containing isocyanurate, biuret, allophanate, iminooxadiazinedione, urethane, urea and/or uretdione groups. Polyisocyanates containing urethane groups, for example, are obtained by reacting some of the isocyanate groups with polyols, such as trimethylolpropane and glycerol, for example. Preference is given to using aliphatic or cycloaliphatic polyisocyanates, especially hexamethylene diisocyanate, dimerized and trimerized hexamethylene diisocyanate, isophorone diisocyanate, 2-isocyanatopropylcyclohexyl isocyanate, dicyclohexylmethane 2,4′-diisocyanate, dicyclohexylmethane 4,4′-diisocyanate or 1,3-bis(isocyanatomethyl)cyclohexane, diisocyanates derived from dimer fatty acids, as sold under the commercial designation DDI 1410 by Henkel, 1,8-diisocyanato-4-isocyanatomethyloctane, 1,7-diisocyanato-4-isocyanatomethylheptane or 1-isocyanato-2-(3-isocyanatopropyl)cyclohexane or mixtures of these polyisocyanates. When the functional group is amine, the curing agent can be polyisocyanate or polyepoxide or polyanhydride; when the functional group is carboxylic acid, the curing agent can be polyepoxide or polyanhydride; when the functional group is epoxy, the curing agent can be polyacid or polyamine.

With preference, the hardener component B comprises at least one polyisocyanate, preferably at least one aliphatic or cycloaliphatic polyisocyanate, very preferably hexamethylene diisocyanate and/or dimerized and/or trimerized hexamethylene diisocyanate.

Mixing of components Aᵢ, optionally with the hardener component(s) B, in steps (a-4) and (a-5) or mixing of the base components BCᵢ with the hardener component B to prepare the first coating composition C₁ and/or the further coating composition(s) Cₓ can be performed in numerous ways known in the state of the art.

In one example, each component Aᵢ is mixed, optionally with the hardener component(s) B, in the selected mixing ratios prior to supplying the resulting first coating composition C₁ and/or the resulting further coating compositions Cₓ to an application equipment. In case the coating composition(s) C₁/Cₓ are prepared by mixing at least one base component BCᵢ with the at least one hardener component B, said at least one base component BCᵢ is mixed with the at least one hardener component B prior to supplying the resulting first coating composition C₁ and/or the resulting further coating composition(s) Cₓ to an application equipment. The order of mixing the components (A₁, . . . , Aₙ) and optionally the hardener component B is not critical and can be varied. For example, components (A₁, . . . , Aₙ) can be mixed prior to mixing the obtained mixture with the hardener component B (if appropriate) or part of the components (A₁, . . . , Aₙ) can be mixed in a first step while mixing the remaining part of components (A₁, . . . , Aₙ) with the hardener component B in a second step or vice versa. Afterwards, the obtained mixtures from step 1 and 2 are combined. Mixing can either be performed manually or using commonly known mixing equipments. The reservoirs used for mixing can either be connected directly to the application equipment or the mixed coating composition(s) C₁ and/or Cₓ can be filled into respective reservoirs attached to an application equipment after the mixing operation. Suitable reservoirs include cans, containers etc., which are suitable to store coating compositions or parts thereof and which allow attachment to an application device, for example via a line. Preparing the coating compositions prior to applying them onto the target areas of the object may be preferred if steps (a) and (b) are performed sequentially.

In another example, the first coating composition C₁ and/or the further coating composition(s) Cₓ are each obtained by mixing components Aᵢ, optionally with the hardener component(s) B, in the selected mixing ratios within an application equipment. In case the coating composition(s) C₁/Cₓ are prepared by mixing at least one base component BCᵢ with the at least one hardener component B, said at least one base component BCᵢ is mixed with the at least one hardener component B within an application equipment. Mixing within an application equipment may be facilitated by attaching respective reservoirs containing the provided components (A₁, . . . , Aₙ) or the at least one base component BCᵢ and optionally the hardener component B to the spraying equipment and mixing the attached components within the atomizer of the spraying equipment by providing the selected mixing ratio(s) and information on the components to the spraying equipment. Mixing may also be facilitated by mixing at least part of the components Aᵢ or BCᵢ with the hardener component B prior to supplying said mixture to the application equipment. In this case, the remaining components Aₙ₋ᵢ, optionally mixed with the hardener component B, or the hardener component B are supplied to the mixing equipment by additionally attaching reservoirs containing said remaining components to the application equipment. Suitable spraying equipment's which allow attachment of at least two different reservoirs and mixing of the components present within at least two attached reservoirs within the atomizer include, for example, the commercially available EcoBell 3 2X2K from Dürr. Preparation of the coating compositions within the application equipment avoids the use of a separate mixing device and allows to automatically control the mixing ratio to produce reproducible coating composition(s) C₁ and/or Cₓ. Performing mixing within the application equipment reduces the time span necessary to produce and apply the coating composition because steps (a) and (b) can be performed right after each other with only a minimal time difference between preparing the coating composition(s) C₁ and/or Cₓ and applying the prepared coating compositions, thus significantly reducing the overall time necessary to perform the inventive process. Additionally, the time for cleaning the application equipment compared to the use of different coating compositions is reduced because the same components are used to prepare coating composition(s) C₁ and/or Cₓ having different leveling properties and/or a different sag resistance, rendering cleaning of the application equipment superfluous.

Coating Compositions C₁ and Cₓ Provided in Step (a):

The coating composition C₁ provided in step (a) and each and each further coating composition Cₓ provided upon repeating step (a) at least once may be a liquid solvent- or water-based coating composition. With preference, the coating composition C₁ provided in step (a) and each further coating composition Cₓ provided upon repeating step (a) at least once is a liquid solvent-based coating composition. In particular, the coating composition C₁ provided in step (a) and each further coating composition Cₓ provided upon repeating step (a) at least once is a liquid solvent-based coating composition.

The coating composition C₁ provided in step (a) and each further coating composition Cₓ provided upon repeating step (a) at least once can be transparent, semi-transparent or opaque. Opaque coating compositions are colored coating compositions which, when applied onto an object, have a luminous transmittance of less than 4 percent as measured at a film thickness of 15 to 18 micrometers according to ASTM D 1003-00 (procedure A) using a CIE standard illuminant D65. Suitable opaque coating compositions include basecoat compositions comprising color and/or effect pigment(s) in a concentration which is high enough to achieve the aforementioned luminous transmittance. In contrast, semi-transparent coating compositions have a luminous transmittance of at least 4 percent when applied onto an object. Semi-transparent coating compositions are therefore neither fully transparent nor opaque. In contrast to transparent coating compositions, semi-transparent coating compositions contain color and/or effect pigments and/or matting agents such that they are not fully transparent. Semi-transparent coating compositions can be colored semi-transparent coating compositions, such as tinted clearcoat compositions. Transparent coating compositions preferably include clearcoat compositions.

According to a preferred embodiment, at least one provided coating composition has good leveling properties while at least one further provided coating composition has a good sag resistance. The term “provided coating composition” refers to the provided coating composition C₁ and the further coating composition(s) Cₓ provided upon repeating step (a) at least once. This allows to match the leveling properties and/or the sag resistance of the coating compositions to the orientation of the target areas, resulting in a better overall appearance of the coated object.

### Binder:

In an embodiment, each provided coating composition comprises at least one binder. The at least one binder present in each provided coating composition may be identical to at least one binder being present in the other provided coating composition or the at least one binder being present in each provided coating composition may be different from the binder(s) present in the other provided coating composition. It may be beneficial if each coating composition comprises at least one identical binder, i.e. each provided coating composition contains at least one binder being identical to the binder(s) present in the other provided coating composition. This allows to prepare the coating compositions from components (A₁, . . . , Aₙ) as described previously without the occurrence of unwanted incompatibilities having a negative influence on the overall appearance of the resulting coating layer or the application of the resulting coating composition.

Suitable binders include (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof. With particular preference, the at least one binder is selected from hydroxy-functional poly(meth)acrylates and/or polyesters.

The hydroxy-functional (meth)acrylate(s) may contain—in polymerized form—at least one unsaturated monomer comprising at least one acid group M1, at least one unsaturated aliphatic and/or cycloaliphatic monomer M2, at least one unsaturated aromatic monomer M3 and at least one unsaturated hydroxy-group containing monomer M4. Where it is stated in the context of the present invention that the hydroxy-functional (meth)acrylate(s) comprises components M1 to M4 in polymerized form, this means that these particular components are used as starting compounds for the preparation of the hydroxy-functional (meth)acrylate(s) in question. Since the monomers M1 to M4 can be polymerized via their unsaturated moieties, the hydroxy-functional (meth)acrylate(s) preferably comprises the unsaturated moieties, previously present in monomers M1 to M4, in the form of C—C single bonds, in other words in their correspondingly reacted form.

Suitable unsaturated monomers comprising at least one acid group M1 include (meth)acrylic acid.

The at least one unsaturated aliphatic monomer M2 can be selected from alkyl (meth)acrylates, more preferably from C₁-C₂₂ alkyl (meth)acrylates, even more preferably from C₁-C₁₄ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₁₃ alkyl (meth)acrylates, very preferably from butyl (meth)acrylate and/or (meth)acrylic ester 13.0.

Suitable unsaturated cycloaliphatic monomers M2 include cycloalkyl (meth)acrylates, such as cyclo-C₅-C₇-alkyl (meth)acrylates, in particular cyclohexyl (meth)acrylate.

The at least one unsaturated aromatic monomer M3 can be selected from styrene. Suitable unsaturated hydroxy-group containing monomers M4 include hydroxyl group-containing (meth)acrylates, more preferably hydroxy C₁-C₁₂ alkyl group-containing (meth)acrylates, such as 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, in particular 2-hydroxyethyl (meth)acrylate and 3-hydroxypropyl (meth)acrylate.

The hydroxy-functional (meth)acrylates can be prepared in organic solvents by polymerizing the aforementioned unsaturated monomers M1 to M4 in the presence of free radical initiators. The free radical initiators can be selected from t-amylperoxy compounds such as 1,1-di(t-amylperoxy)cyclohexane, t-amylperoxy esters such as t-amylperoxy, ethyl-3,3-di(t-amylper-oxy)butyrate and t-amylperoxyacetate, other peroxides such as di-t-butylperoxide, dicumylperoxide, cumenehydroperoxide, and t-butylperbenzoate and azo compounds such as 2,2′-azobis(2-methylbuty-ronitrile). The amount of free radical initiator that is used will vary in amounts from about 0.5 to 10 wt.-%, preferably 1 to 4 wt.-%, based on total weight of monomers M1 to M4.

In some embodiments, the at least one binder is a polyester. Suitable polyesters can be prepared by reacting poly-functional acid or anhydride compounds or a mixture of mono-functional and poly-functional acid or anhydride compounds with polyfunctional alcohols. Typical acid compounds include alkyl, alkylene, aralkylene, and aromatic monocarboxylic acids, dicarboxylic acids and anhydrides; however, acids or anhydrides with higher functionality may also be used. If tri-functional compounds or compounds of higher functionality are used, these may be used in mixture with mono-functional carboxylic acids or anhydrides of monocarboxylic acids, such as versatic acid, fatty acids, or neodecanoic acid. Illustrative examples of acid or anhydride functional compounds suitable for forming the polyester groups or anhydrides of such compounds include phthalic acid, phthalic anhydride, isophthalic acid, terephthalic acid, hexahydrophthalic acid, tetrachlorophthalic anhydride, hexahydrophthalic anhydride, pyromellitic anhydride, succinic acid, azeleic acid, adipic acid, 1,4-cyclohexanedicarboxylic acid, citric acid, and trimellitic anhydride.

The polyol component used to make the polyester has a hydroxyl functionality of at least two. The polyol component may contain mono-, di-, and tri-functional alcohols, as well as alcohols of higher functionality. Diols are a typical polyol component. Alcohols with higher functionality may be used where some branching of the polyester is desired, and mixtures of diols and triols can be used as the polyol component. However, in some cases, highly branched polyesters are not desirable due to effects on the coating, such as decreased flow, and undesirable effects on the cured film, such as diminished chip resistance and smoothness. Examples of useful polyols include, but are not limited to, ethylene glycol, diethylene glycol, triethylene glycol, propylene glycol, dipropylene glycol, butylene glycol, glycerine, trimethylolpropane, trimethylolethane, pentaerythritol, neopentyl glycol, 2,2,4-trimethyl-1,3-pentanediol, 1,6-hexanediol, 1,4-cyclohexane dimethanol, hydrogenated bisphenol A, and ethoxylated bisphenols. Methods of making polyesters are well-known. Polyesters are typically formed by heating together the polyol and poly-functional acid components, with or without catalysis, while removing the by-product of water in order to drive the reaction to completion. A small amount of a solvent, such as toluene, may be added in order to remove the water azeotropically.

The at least one binder is preferably present in each provided coating composition in a total amount of 10 to 70 wt.-%, preferably of 20 to 60 wt.-%, more preferably 25 to 55 wt.-%, very preferably of 30 to 45 wt.-%, based in each case on the total weight of the provided coating composition. If more than one binder is present, for example a mixture of hydroxy-functional poly(meth)acrylates and polyesters, the aforementioned amounts refer to the total amount of binders present in the respective provided coating composition and thus refer to the sum of the amounts of hydroxy-functional poly(meth)acrylates and polyester(s).

### Sagging Control Agent (SCA):

The specific leveling properties and/or the specific sag resistance of the provided coating composition are achieved by the presence of at least one sagging control agent (SCA) in at least one provided coating composition. The use of the sagging control agent (SCA) allows to adjust the thixotropic rheological behavior of the provided coating compositions. SCA's affect the sag-leveling properties of a coating composition as the SCA particles tend to form a loose, percolating network at low shear stress through controlled flocculation. At high shear stress (e.g. during spraying of the coating composition) the SCA-network is destroyed and the effect of SCA-addition on the high-shear viscosity is nearly zero as SCA's are typically used in low concentrations. After application, the wet coating composition experiences a low (gravitational) shear stress. Under these low-shear conditions the SCA-network builds up resulting in an increase of the viscosity. This shear-thinning behavior of SCA-modified coating compositions is beneficial as it increases the sag resistance of the paint. As the rate of formation of the SCA-network is relatively slow, SCA-modified coating compositions are often thixotropic. Thus, provided coating composition(s) containing higher amounts of SCA have a better sag resistance than provided coating composition(s) containing lower amounts of SCA or being free of SCA (i.e. containing SCA in a total amount of less than 1 wt.-%, preferably of 0 wt.-%, based on the total weight of the coating composition). However, provided coating composition(s) containing lower amounts of SCA or being free of SCA have better leveling properties. Thus, the addition of SCA can be used to adjust the sag resistance and/or leveling properties of each provided coating composition such that coating compositions having specific leveling properties and/or a specific sag resistance being different from the leveling properties and/or the sag resistance of the other provided coating compositions is achieved. This allows to tune the leveling properties and/or the sag resistance such that they match the properties of the target area(s), the respective coating composition is to be applied to in step (b).

The SCA's are normally anisotropic, colloidal particles that are formed by crystallization of urea molecules. The urea molecules can be obtained by reacting an isocyanate compound with a primary or secondary amine, optionally in the presence of a resin, such as a (meth)acrylate resin. The isocyanate compound be an isocyanate functional polymer, such as an isocyanate functional (meth)acrylic polymer, or can be a commonly known polyisocyanate. The reaction between the isocyanate compound and the primary or secondary amine may generally be carried out in any arbitrarily chosen way by combining the reaction components, optionally in the presence of the resin. The reaction may be carried out at a temperature in the range of 20° to 120° C., more particularly in the range of 25° to 95° C. In general, the primary or secondary amine is added directly to the isocyanate compound at the desired reaction temperature optionally in the presence of catalyst such as a tin compound. The reaction proceeds until the isocyanate has been completely consumed. In case the reaction is performed in the presence of a resin, the isocyanate compound and the primary or secondary amine are added to the resin, either together or sequentially.

It is preferred within the present invention if the sagging control agent (SCA) is selected from polymeric sagging control agents. The term “polymeric sagging control agents” refers to SCA's which are either obtained by reacting an isocyanate functional polymer with a primary or secondary amine or which are obtained by reacting a polyisocyanate with a primary or secondary amine in the presence of at least one resin. Thus, SCA's prepared by reacting polyisocyanates with amines are not encompassed by the term “polymeric sagging control agent”.

The polymeric sagging control agent (SCA) may be obtained by reacting a primary or secondary amine with an isocyanate compound in the presence of a hydroxy-functional poly(meth)acrylate. Suitable polyisocyanates that can be used for the formation of the SCA's include blocked or un-blocked aliphatic, cycloaliphatic, heterocyclic, aromatic di-, tri-, polyisocyanates or a combination thereof. Examples of suitable polyisocyanates can include 1,6-hexamethylene diisocyanate, 2,2,4-trimethylhexane-1,6-diisocyanate, 2,4,4-trimethylhexane-1,6-diisocyanate, cyclohexyl-1,4-diisocyanate, isophorone diisocyanate, the adduct of 1 molecule of 1,4-butanediol and 2 molecules of isophorone diisocyanate, the adduct of 1 molecule of 1,4-butanediol and 2 molecules of hexamethylene diisocyanate, dicyclohexylmethane-4,4′-diisocyanate, xylene diisocyanate, 1,3,5-trimethyl-2,4-bis(isocyanatomethyl)benzene, toluene diisocyanate, diphenylmethane-4,4′-diisocyanate, adducts of hexamethylene diisocyanate, adducts of isophorone diisocyanate, and adducts of toluene diisocyanate. Isocyanurate-trimers of diisocyanates can also be suitable. In some embodiments, aliphatic polyisocyanates, such as hexamethylene diisocyanate, are used.

Examples of primary amines would include benzylamine, ethylamine, n-propylamine, see propylamine, n-butylamine, sec. butylamine, tert. butylamine, n-pentylamine, alpha-methylbutylamine, alpha-ethylpropylamine, beta-ethylbutamine, hexylamine, octylamine, decylamine, stearylamine, cyclohexylamine, aniline and hexamethylene diamine. Examples of suitable secondary amines would include dibutylamine, diethylamine, diisopropylamine, diethanolamine, and diisopropanolamine. These amines would generally contain not more than 30 carbon atoms and preferably 1 to 18 carbon atoms. Amines containing one or more primary or secondary amino groups and one or more ether and/or hydroxyl groups are also applicable. For example, ethanolamine, 6-aminohexanol, p-methoxybenzylamine, methoxypropylamine, 3,4-dimethoxyphenyl-ethylamine, 2,5-dimethoxyaniline, furfurylamine, tetrahydrofurfurylamine may be used. Mixture of the amines referred to above may also be used. In some embodiments, aromatic primary amines, such as benzylamine, are used.

Suitable hydroxy-functional poly(meth)acrylates contain—in polymerized form—at least one unsaturated monomer comprising at least one acid group M1, at least one unsaturated aliphatic monomer M2, at least one unsaturated aromatic monomer M3 and at least one unsaturated hydroxy-group containing monomer M4.

Suitable unsaturated monomers comprising at least one acid group M1 include (meth)acrylic acid.

The at least one unsaturated aliphatic monomer M2 can be selected from alkyl (meth)acrylates, more preferably from C₁-C₂₂ alkyl (meth)acrylates, even more preferably from C₁-C₁₄ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₁₃ alkyl (meth)acrylates.

The at least one unsaturated aromatic monomer M3 can be selected from styrene. Suitable unsaturated hydroxy-group containing monomers M4 include hydroxyl group-containing (meth)acrylates, such as C₁-C₁₂ alkyl group-containing (meth)acrylates selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate.

With particular preference, the hydroxy-functional poly(meth)acrylates contain—in polymerized form—(meth)acrylic acid, butyl (meth)acrylate and/or (meth)acrylic ester 13.0, styrene and 2-hydroxyethyl (meth)acrylate.

Suitable weight ratios of monomers M1:M2:M3:M4 include 1:50:50:30 to 1:30:20:10.

The hydroxy-functional poly(meth)acrylate can be prepared as previously described in relation to the hydroxy-functional poly(meth)acrylate binder by radical free polymerization of monomers M1 to M4.

The polymeric sagging control agent (SCA) may have an average molecular weight Mw of 3,000 to 50,000 g/mol, preferably of 4,000 to 30,000 g/mol, very preferably of 5,000 to 15,000 g/mol, as determined with GPC using polystyrene as internal standard.

The viscosity of the sagging control agent may range from 500 to 4,000 mPa*s, preferably from 700 to 3,000 mPa*s, very preferably from 1,000 to 2,500 mPa*s (25° C., 10/s, Z3) (DIN ISO 2884-1:2006-09).

The hydroxy-functional poly(meth)acrylate used to prepare the polymeric sagging control agent is preferably also present in provided coating composition(s) comprising no polymeric sagging control agent or comprising lower amounts of polymeric sagging agent as compared to provided coating composition(s) comprising higher amounts of polymeric sagging agent. This allows to prepare the provided coating compositions from components (A₁, . . . , Aₙ) as described previously without the occurrence incompatibilities, which may result in clogging of the application equipment during application of the coating compositions or a reduced optical quality of the resulting coating layer.

With preference, the sagging control agent (SCA), in particular the polymeric sagging control agent, is present in a total amount of 0.1 to 40 wt.-%, preferably of 2 to 30 wt.-%, more preferably of 3 to 20 wt.-%, very preferably of 4 to 15 wt.-%, based in each case on the total weight of the respective provided coating composition Depending on the amount of SCA in each provided coating composition, each coating composition either has good leveling properties (low amounts of SCA or no SCA present) or a good sag resistance (high amounts of SCA present), as previously described.

Further Additives Apart from SCA:

Apart from the SCA, at least one provided coating composition may further comprise at least one additive being different from the sagging control agent (SCA).

In one example, all provided coating compositions further comprise the at least one additive, in particular similar additive(s). This allows to prepare the provided coating compositions from components (A₁, . . . , Aₙ) as described previously without the occurrence incompatibilities during the preparation of the provided coating compositions.

In another example, only part of the provided coating compositions comprise the further additive(s) while the other part of the provided coating compositions does not contain said additives (i.e. contains 0 wt.-%, based on the total weight of the respective coating composition, of further additives). This may be preferred if, for example, the provided coating composition(s) having good leveling properties consists of the hydroxy-functional poly(meth)acrylate used to prepare the SCA while the provided coating composition(s) having a good sag resistance contain(s) a binder, such as the hydroxy-functional poly(meth)acylate described previously, the SCA and the further additive(s).

Suitable additives being different from the sagging control additive include crosslinking agents, light stabilizers, leveling agents, UV absorbers, pigments, free-radical scavengers, slip additives, polymerization inhibitors, defoamers, wetting agents, adhesion promoters, flow control agents, film-forming assistants such as cellulose derivatives, fillers, rheology control additives, flame retardants and/or water scavengers, in particular crosslinking agents, light stabilizers and leveling agents.

Suitable leveling agents include silicon-containing leveling agents, such as silicone-containing leveling agents having the following structural formula:

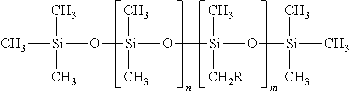

in which
R stands for hydrogen, an alkyl residue, an alkylaryl residue, a glycol residue, a hydroxy group, a hydroxyalkyl residue, an amino group or a aminoalkyl residue, and
n and m are positive integers, respectively.

Representative silicone-containing leveling agents are dimethyl polysiloxane (R═H in the above formula) and modified silicone leveling agents in which R in the above formula is alkyl such as methyl, ethyl, propyl and the like, alkylaryl such as methylaryl, ethylaryl, and the like, glycol residue, hydroxy, hydroxyalkyl such as hydroxymethyl, hydroxyethyl, and amino.

In a preferred embodiment, the provided coating compositions only differ in the amount and/or type of leveling agent(s) and/or sagging control agent(s) (SCA) and/or solvent(s). The at least one solvent may be used to compensate for the absence of the SCA in coating composition(s) being free of SCA or comprising lower amounts of SCA than coating composition(s) comprising higher amounts of SCA. In case of solvent-based coating compositions, the at least one solvent may be an organic solvent commonly used in solvent-based coating compositions, such as solvent naphtha. In one example of this preferred embodiment, exactly two coating compositions are provided, wherein one of the two provided coating compositions contains SCA while the other is free of SCA and contains additional amounts of solvent to compensate the absence of the SCA. Both coating compositions contain the leveling agent(s).

### Step (b):

In step (b) of the inventive process, the first coating composition C₁ provided in step (a) is applied onto at least part of the plurality of target areas having first properties P₁. Preferred properties P₁ are the orientation of the target area. The orientation may include vertical orientation or horizontal orientation.

Application of the coating composition C₁ in step (b) can be performed with any type of application equipment known to apply a coating composition to an object and may include, for example, dipping coating equipment, bar coating equipment, spraying equipment, rolling equipment or the like. With particular preference, step (b) is performed using a spray application equipment. Suitable spray application equipments include compressed air spraying equipments (pneumatic spraying equipment), airless spraying equipments, high-speed rotation equipments or electrostatic spray application equipments (ESTA), optionally in association with hot-spray, for example hot-air spraying equipments.

The coating composition C₁ may be applied onto all target areas having first properties P1 or onto only a part of the target areas having properties P₁. With preference, the coating composition C₁ is applied onto all target areas having properties P₁. This avoids switching of the coating compositions during application, thus reducing cleaning times and material consumption.

With particular preference, a coating composition C₁ having high leveling properties is applied on horizontally oriented areas while a coating composition C₁ having a high sag resistance is applied on vertically oriented areas. This allows to achieve an overall high quality of the final coating because a coating composition having leveling properties and/or a sag resistance tuned to the orientation of the object is applied, thus reducing or diminishing the amount of film defects due to improver leveling or the occurrence of sagging of the applied coating composition.

The application of the coating composition C₁ is effected in such a way that the coating layer, after the curing in step (d), has a dry film thickness of, for example, 15 to 80 micrometers, preferably 20 to 65 micrometers, especially preferably 25 to 60 micrometers.

The process of this invention is suitable for coating a variety of metallic and non-metallic objects in a batch or continuous process. In a batch process, also referred to as a modular process, the object is stationary during each treatment step of the process, whereas in a continuous process the object is in continuous movement along the paint line in an assembly line fashion.

Suitable objects to be coated according to the method of the invention include (i) uncoated metal objects or metal objects being coated with a cured electrocoat layer and/or a cured filler layer and/or a non-cured basecoat layer; (ii) plastic objects optionally being coated with a cured primer layer and/or a non-cured basecoat layer; and (iii) objects comprising metallic and plastic parts and optionally being coated with a cured electrocoat layer and/or a cured filler layer and/or a cured primer-surfacer layer and/or a cured primer layer and/or a non-cured basecoat layer, preferably from metal objects being coated with a cured electrocoat layer and/or a cured filler layer and/or a non-cured basecoat layer, very preferably from metal objects being coated with a cured electrocoat layer and a non-cured basecoat layer. The objects preferably comprise areas having different orientations relative to each other, such as vertically oriented areas and horizontally oriented areas.

Suitable metal objects are selected from the group comprising or consisting of steel, iron, aluminum, copper, zinc and magnesium objects as well as objects made of alloys of steel, iron, aluminum, copper, zinc and magnesium.

Coated and uncoated metal objects can be pretreated in a manner known per se, i.e., for example, cleaned and/or provided with known conversion coatings. Cleaning can be effected mechanically, for example by means of wiping, grinding and/or polishing, and/or chemically by means of etching methods, such as surface etching in acid or alkali baths using, for example, hydrochloric acid or sulfuric acid, or by cleaning with organic solvents or aqueous detergents. Pretreatment by application of conversion coatings, especially by means of phosphation and/or chromation, preferably phosphation, may likewise take place. Preferably, the metallic objects are at least conversion-coated, especially phosphated, preferably by a zinc phosphation. Metal objects being coated with a cured electrocoat are produced by electrophoretic application of an electrocoat material to the object and subsequent curing of the applied electrocoat material. The electrocoat material may be a cathodic or anodic electrocoat material, preferably a cathodic electrocoat material. Electrocoat materials are aqueous coating materials comprising anionic or cationic polymers as binders. These polymers contain functional groups which are potentially anionic, i.e. can be converted to anionic groups, for example carboxylic acid groups, or functional groups which are potentially cationic, i.e. can be converted to cationic groups, for example amino groups. The conversion to charged groups is generally achieved by the use of appropriate neutralizing agents (organic amines (anionic), organic carboxylic acids such as formic acid (cationic). The electrocoat materials generally comprise typical anticorrosion pigments. The cathodic electrocoat materials preferred in the context of the invention comprise preferably cationic polymers as binders, especially hydroxy-functional polyether amines, which preferably have aromatic structural units. These polymers are especially used in combination with blocked polyisocyanates known per se. The application of the electrocoating material proceeds by electrophoresis. For this purpose, the metallic workpiece to be coated is first dipped into a dip bath containing the coating material, and an electrical DC field is applied between the metallic workpiece and a counterelectrode. The workpiece thus functions as an electrode; the nonvolatile constituents of the electrocoat material migrate, because of the described charge of the polymers used as binders, through the electrical field to the object and are deposited on the object, forming an electrocoat film. For example, in the case of a cathodic electrocoat, the object is thus connected as the cathode, and the hydroxide ions which form there through water electrolysis neutralize the cationic binder, such that it is deposited on the object and forms an electrocoat layer. After the electrolytic application of the electrocoat material, the coated object is removed from the bath, optionally rinsed off with, for example, water-based rinse solutions, then optionally flashed off and/or intermediately dried, and finally cured. The dry film thickness of the cured electrocoat is, for example, 10 to 40 micrometers, preferably 15 to 25 micrometers.

Metal objects being coated with a cured filler layer are produced by applying a filler coating composition to the object, optionally flashing off and/or intermediately drying said applied composition and finally curing said composition. Suitable filler coating compositions are known in the state of the art. The dry film thickness of the cured filler layer is, for example, 10 to 40 micrometers, preferably 25 to 30 micrometers.

Metal objects being coated with a non-cured basecoat layer a produced by applying at least one basecoat composition to the object optionally being coated with at least one cured or non-cured coating layer and optionally flashing off and/or intermediately drying said applied basecoat composition. The dry film thickness of the cured basecoat layer is, for example, 5 to 40 micrometers, preferably 10 to 30 micrometers.

Preferred plastic objects are basically objects comprising or consisting of (i) polar plastics, such as polycarbonate, polyamide, polystyrene, styrene copolymers, polyesters, polyphenylene oxides and blends of these plastics, (ii) synthetic resins such as polyurethane RIM, SMC, BMC and (iii) polyolefin objects of the polyethylene and polypropylene type with a high rubber content, such as PP-EPDM, and surface-activated polyolefin objects. The plastics may furthermore be fiber-reinforced, in particular using carbon fibers and/or metal fibers.

Preferably, the objects to be coated according to the process of the present invention are used as components to fabricate vehicles, preferably automotive vehicles, including but not limited to automobiles, trucks, and tractors. The objects can have any shape, but are usually in the form of automotive body components such as bodies, hoods, doors, fenders, bumpers and/or trims for automotive vehicles. The invention is most useful in the context of coating automotive bodies and components thereof traveling in continuous movement along an automotive assembly line.

### Step (c):

In step (c) of the inventive process, steps (a) and (b) are repeated at least once with the following conditions:
the specific leveling the specific leveling properties and/or a specific sag resistance of each further coating composition Cₓ provided upon repeating step (a) differ from the specific leveling properties and/or the specific sag resistance of the previously provided coating composition P₁ and each previously provided further coating composition Cₓ, and
each coating composition Cₓ is applied onto at least part of the plurality of target areas having properties being different from the properties P₁ and the properties of each further previously coated target areas upon repeating (b)

Thus, the at least one further coating composition Cₓ provided upon repeating step (a) has different specific leveling properties and/or a different specific sag resistance than the first coating composition C₁ and any previously provided further coating composition Cₓ. The further coating composition Cₓ can be provided as described in relation to the first coating composition C₁. The different specific leveling properties and/or the different specific sag resistance can be obtained by using different amounts of leveling additives and/or sag control agents (SCAs) as previously described in relation to the first coating composition C₁.

It is essential that the coating composition(s) provided upon repeating step (a) each have specific leveling properties and/or a specific sag resistance which are different from the leveling properties and/or the sag resistance of the other coating compositions previously provided to achieve a higher quality in terms of overall appearance of the resulting coated object by applying a coating composition having specific leveling properties and/or a specific sag resistance to a target area having properties matching said leveling properties and/or said sag resistance, such as the matching orientation.

The provided at least one further coating composition Cₓ is applied onto the object by repeating step (b). However, the at least one further coating composition Cₓ is applied onto target area(s) having properties being different from properties P₁ and properties of each further previously coated target area. Thus, each coating composition Cₓ is not applied to target areas having the same properties as target areas previously coated with the coating composition C₁ or any previously prepared and applied coating composition Cₓ. Application of the at least one further coating composition Cₓ can be performed as described previously in relation to application of the first coating composition C₁.

It is essential that the further coating compositions Cₓ are applied to target areas having different properties than the previously coated target areas, because the further coating compositions Cₓ have different specific leveling properties and/or a different specific sag resistance than the previously provided coating compositions Cₓ. Thus, application of a coating composition Cₓ onto a target area having the same properties a target area previously coated with the first coating composition C₁ or a previously provided coating composition Cₓ would result in coating said target area with a coating composition having leveling properties and/or a sag resistance with are not or only partially matched to the properties of said target area(s), thus resulting in reduced quality of the overall optical appearance as compared to fully matching the leveling properties and/or the sag resistance with the properties of the target area(s).

The order of step (b) and repetition of step (a) is not critical and can be reversed. In one example, steps (a) and (b) are performed prior to repeating steps (a) and (b) at least once. In another example, repetition of step (a) at least once is performed prior to performing step (b), i.e. at least two coating compositions having different leveling properties and/or a different sag resistance are provided prior to applying said provided compositions to the target areas in step (b) and upon repeating step (b) at least once.

### Optional Step (d):

In step (d) of the inventive method, steps (a) and (b) may be repeated with the proviso that the coating compositions C₁ and Cₓ are applied to the remaining target areas having the same properties as the target areas to which coating compositions C₁ and Cₓ were applied in a previous step (b). This step is generally optional and only needs to be performed in case at least part of the target areas having specific properties were coated with the first coating composition C₁ in step (b) or at least one further coating composition Cₓ upon repeating step (b) at least once.

### Step (e):

The inventive method may further include a step (e) of curing or drying and curing the applied the coating composition(s). Curing or drying and curing may either be performed after applying all coating compositions to all target areas or after application of each coating composition to at least part of the target areas. Performing step (e) after application of all coating compositions to all target areas is more energy efficient because the curing operation requiring high temperatures is only performed once. Drying can be performed at 15 to 35° C. for a period of 10 to 30 minutes. Curing is preferably effected at temperatures of 80 to 250° C., preferably of 80 to 180° C., for a period of 5 to 60 min, preferably 10 to 45 min. Curing conditions of this kind apply especially to the preferred case that the coating composition(s) are based on thermally curable 2K coating composition(s), since these conditions are necessary to achieve curing of such 2K coating composition(s).

The inventive process allows to match the leveling properties and/or the sag resistance of coating compositions to the properties of the respective target areas, for example to the orientation of the target area(s) to be coated with the respective coating composition. This allows to achieve a higher overall optical quality than using a coating composition having balanced leveling properties and sag resistance because leveling properties and sag resistance are conflicting properties which cannot be adjusted without negatively influencing each other. In principle, coating compositions having appropriate leveling properties or an appropriate sag resistance can be obtained by mixing only two components A₁ and A₂, namely a component not comprising SCA and having high leveling properties and a component comprising high amounts of SCA and having a high sag resistance in an appropriate mixing ratio, thus allowing to obtain the coating compositions having the required properties from a minimum number of components. This reduces the number of coating compositions which need to be stocked or attached to the application equipment, thus reducing the overall costs associated with the inventive process.

### Inventive Use:

A further subject-matter of the present invention is the use of the inventive process for coating target areas of an object having different orientations relative to each other.

Use of the inventive process results—as previously described—in a higher overall optical quality of the coated object because the coating composition having appropriate leveling properties and/or an appropriate sag resistance can be applied to the target area having the orientation matching the leveling properties and/or the sag resistance of the coating composition.

What has been said about the process according to the invention applies mutatis mutandis with respect to further preferred embodiments of the inventive use.

### Inventive System:

A further subject matter of the present invention is a system for applying at least two coating compositions having different leveling properties and/or a different sag resistance to an object comprising a plurality of two target areas, at least part of the plurality of target areas having different properties.

The system comprises an application device comprising a nozzle, a storage device for storing application instructions and optionally mixing ratio instructions, one or more data processors configured to execute the application instructions and optionally the mixing ratio instructions to control the application device and at least two reservoirs in fluid communication with the application device comprising at least two components (Aᵢ)_{i=1, . . . , n} and optionally at least one hardener component B or at least two coating compositions (Cᵢ)_{i=1, . . . , n}. Each component Aᵢ has different leveling properties and/or a different sag resistance or each coating composition Cᵢ has specific leveling properties and/or a specific sag resistance. As previously mentioned with respect to step (a) of the inventive method, at least part of the components Aᵢ may already be mixed with the binder component B such that the reservoir may contain component Aᵢ and binder B.

In one embodiment of the system, the application device is configured to receive the respective components Aᵢ and/or B from the reservoir and to mix the respective components Aᵢ and/or B based on the mixing ratio instructions within the nozzle. Afterwards, the resulting coating compositions (Cᵢ)_{i=1, . . . , n} are expelled through the nozzle based on the application instructions to at least two target coating areas having different properties such that at least part of each coating composition Cᵢ is not expelled onto target areas having the same properties. This embodiment is preferred if the coating compositions to be expelled onto the target areas need to be generated from at least two different components having different leveling properties and/or a different sag resistance and a separate mixing step outside of the application device should be avoided.

In an alternative embodiment of the system, the application device is configured receive at least two coating compositions (Cᵢ)_{i=1, . . . , n} from the reservoir to expel the coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object. This embodiment may be preferred if coating compositions already having leveling properties and/or a sag resistance which is required for (i.e. matches) the properties of the respective target area(s) are used.

In both embodiments, the same coating composition is not expelled onto target areas having different properties, i.e. a coating composition having defined leveling properties and/or a defined sag resistance is only expelled to target areas having the same properties and not onto target areas having different properties. This allows to expel a coating composition having specific leveling properties and/or a specific sag resistance to the target area(s) having properties, such as an orientation, matching said specific leveling properties and/or sag resistance.

Suitable application devices include the spray application devices previously mentioned in relation to step (b) of the inventive process.

The term “storage device” may refer to physical and other computer-readable media for carrying or storing computer-executable instructions and/or data structures. Such computer-readable media can be any available media that can be accessed by a general-purpose or special-purpose computer system. Computer-readable media may include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention. The storage device stores application instructions and optionally mixing ratio instructions. Said instructions are computer-executable instructions which allow the computer processors to control the mixing and expelling process performed by the application device.

The one or more computer processors may be present within a computing system. The computing system may further comprise the storage device previously described. The term “processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means, or computer processor may be a multicore processor. Specifically, the processing means, or computer processor may be or may comprise a Central Processing Unit (“CPU”). The processing means or computer processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like.

The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified. The terms “processor” and “computer processor” are used synonymously herein. The processors are configured to execute the application instructions and optionally the mixing ratio instructions and to control the application device upon executing said instructions.

The reservoirs may be any container which is suitable for containing a coating composition or parts thereof and which can be connected to the application device such that the application device can receive the components present within the respective reservoir. Connection between the reservoir and the application device may be facilitated using a line.

In an aspect, the one or more data processors are further configured to generate the application instructions by:
receiving, by the one or more data processors, target image data of the object, the target image data including a plurality of target areas,
generating, based on the received image data, the application instructions.

The target image data of the object may be provided to the data processors from a storage device, such as a database. Retrieval of the data may be performed by entering data being indicative of the object, such as the vehicle identification number, a unique ID, etc. and retrieving the data based on the entered data. In one example, target image data may be an image of the object. In another example, the target image data may be CAD data of the object. The application instructions may be generated by determining the properties of said target areas and generating application instructions based on said determined properties. Determining the properties may be performed based on indications being present in the provided target image data.

The invention is described in particular by the following embodiments:
1. Process for applying at least two coating compositions having different leveling properties and/or a different sag resistance to an object comprising a plurality of target areas, at least part of the plurality of target areas having different properties, said process comprising:
   (a) providing a first coating composition C₁ having specific leveling properties and/or a specific sag resistance,
   (b) applying the first coating composition C₁ provided in step (a) onto at least part of the plurality of target areas having first properties P₁, and
   (c) repeating steps (a) and (b) at least once, wherein
      the specific leveling properties and/or a specific sag resistance of each further coating composition Cₓ provided upon repeating step (a) differ from the specific leveling properties and/or the specific sag resistance of the previously provided coating composition P₁ and each previously provided further coating composition Cₓ, and
      each coating composition Cₓ is applied onto at least part of the plurality of target areas having properties being different from the properties P₁ and the properties of each further previously coated target areas upon repeating (b).
2. Process according to embodiment 1, wherein step (a) includes
   (a-1) providing at least two components (Aᵢ)_{i=1, . . . , n}, having different leveling properties and/or a different sag resistance and optionally at least one hardener component B,
   (a-2) selecting mixing ratio(s) for at least part of the components Aᵢ provided in step (a-1) to achieve specific leveling properties and/or a specific sag resistance of the first coating composition C₁ and/or further coating composition(s) Cₓ,
   (a-3) optionally selecting mixing ratio(s) for the at least one hardener component B provided in step (a-1), and
   (a-4) mixing components Aᵢ, optionally with the at least one hardener component B in the mixing ratio(s) selected in step (a-2) and optionally (a-3) to provide the coating composition C₁ and/or further coating composition(s) Cₓ having specific leveling properties and/or a specific sag resistance.
3. Process according to embodiment 2, wherein step (a-2) includes determining the required specific leveling properties and/or sag resistance of the first coating composition C₁ and/or further coating composition(s) Cₓ and selecting a mixing ratio for at least part of the components provided in step (a-1) such that the specific leveling properties and/or the specific sag resistance of the resulting first coating composition C₁ and/or further coating composition(s) Cₓ is achieved.
4. Process according to embodiment 3, wherein a higher fraction of components provided in step (a-1) and having a high sag resistance is selected in step (a-2) if a higher sag resistance of the coating composition C₁ and/or further coating composition(s) Cₓ is required or wherein a lower fraction of components provided in step (a-1) and having a high sag resistance is selected in step (a-2) if higher leveling properties of the first coating composition C₁ and/or further coating composition(s) Cₓ are required.
5. Process according to any one of embodiments 2 to 4, wherein at least one component Aᵢ provided in step (a-1) comprises at least one binder, in particular each component (A₁, . . . , Aₙ) provided in step (a-1) comprises at least one binder.
6. Process according to embodiment 5, wherein each component Aᵢ provided in step (a-1) comprises at least one binder being identical to at least one binder being present in the other provided components or wherein each component Aᵢ provided in step (a-1) comprises a binder being different from the binder(s) present in the other provided components.
7. Process according to any one of embodiments 2 to 6, wherein the mixing ratios selected in step (a-2) and optional step (a-3) are by volume and/or wherein a volume:volume mixing ratio for the mixture of components Aᵢ and the at least one hardener component B of 8:1 to 1:1, preferably of 4:1 to 1:1 is selected in step (a-3).
8. Process according to embodiment 1, wherein step (a) includes preparing the first coating composition C₁ and/or further coating composition(s) Cₓ having specific leveling properties and/or a specific sag resistance by mixing at least two coating material ingredients.
9. Process according to embodiment 8, wherein the first composition C₁ and/or further coating composition(s) Cₓ are each prepared by mixing at least one base component BCᵢ having specific leveling properties and/or a specific sag resistance with at least one hardener component B.
10. Process according to embodiment 9, wherein a volume:volume mixing ratio of 8:1 to 1:1, preferably of 4:1 to 1:1 is used for mixing the base component BCᵢ with the at least one hardener component B.
11. Process according to any one of embodiments 2 to 10, wherein the at least one hardener component B comprises at least one crosslinking agent being capable of reacting with functional groups of a compound being present in at least one component Aᵢ provided in step (a-1) or the base component BCᵢ.
12. Process according to any one of embodiments 2 to 11, wherein the at least one hardener component B comprises at least one polyisocyanate, preferably at least one aliphatic or cycloaliphatic polyisocyanate, very preferably hexamethylene diisocyanate and/or dimerized and/or trimerized hexamethylene diisocyanate.
13. Process according to any one embodiments 2 to 12, wherein components Aᵢ are mixed, optionally with the hardener component(s) B, in the selected mixing ratios prior to supplying the resulting first coating composition C₁ and/or the resulting further coating compositions Cₓ to an application equipment and/or wherein the at least one base component BCᵢ is mixed with the at least one hardener component B prior to supplying the resulting first coating composition C₁ and/or the resulting further coating composition(s) Cₓ to an application equipment.
14. Process according to any one of embodiments 2 to 12, wherein the first coating composition C₁ and/or the further coating composition(s) Cₓ are each obtained by mixing components Aᵢ, optionally with the hardener component(s) B, in the selected mixing ratios within an application equipment and/or wherein the at least one base component BCᵢ is mixed with the at least one hardener component B within an application equipment.
15. Process according to any one of the preceding embodiments, wherein the different properties include different orientations of at least two target areas relative to each other.
16. Process according to any one of the preceding embodiments, wherein the provided first coating composition C₁ and each provided further coating composition Cₓ is a liquid solvent- or water-based coating composition, preferably a liquid solvent-based coating composition, in particular a liquid solvent-based coating composition.
17. Process according to any one of the preceding embodiments, wherein the provided first coating composition P₁ and each provided further coating composition Cₓ is transparent, semi-transparent or opaque.
18. Process according to any one of the preceding embodiments, wherein at least one provided coating composition has good leveling properties and at least one further provided coating composition has a high sag resistance.
19. Process according to any one of the preceding embodiments, wherein each provided coating composition comprises at least one binder, said at least one binder being identical to at least one binder being present in the other provided coating compositions or wherein each provided coating composition comprises at least one binder being different from the binder(s) present in the other provided coating compositions.
20. Process according to embodiments 5 or 19, wherein the at least one binder is selected from (i) poly(meth)acrylates, more particularly hydroxy-functional and/or carboxylate-functional and/or amine-functional poly(meth)acrylates, (ii) polyurethanes, more particularly hydroxy-functional and/or carboxylate-functional and/or amine-functional polyurethanes, (iii) polyesters, more particularly polyester polyols, (iv) polyethers, more particularly polyether polyols, (v) copolymers in the stated polymers, and (vi) mixtures thereof, in particular from hydroxy-functional poly(meth)acrylates and/or polyesters.
21. Process according to embodiment 20, wherein the hydroxy-functional (meth)acrylate contains—in polymerized form—at least one unsaturated monomer comprising at least one acid group M1, at least one unsaturated aliphatic and/or cycloaliphatic monomer M2, at least one unsaturated aromatic monomer M3 and at least one unsaturated hydroxy-group containing monomer M4.
22. Process according to embodiment 21, wherein the at least one unsaturated monomer comprising at least one acid group M1 is selected from (meth)acrylic acid.
23. Process according to embodiment 21 or 22, wherein the at least one unsaturated aliphatic monomer M2 is selected from alkyl (meth)acrylates, more preferably from C₁-C₂₂ alkyl (meth)acrylates, even more preferably from C₁-C₁₄ alkyl (meth)acrylates such as C₃ alkyl (meth)acrylates, C₄ alkyl (meth)acrylates, C₅ alkyl (meth)acrylates, C₆ alkyl (meth)acrylates, C₇ alkyl (meth)acrylates and C₁₃ alkyl (meth)acrylates, very preferably from butyl (meth)acrylate and/or (meth)acrylic ester 13.0.
24. Process according to any one of embodiments 21 to 23, wherein the at least one unsaturated cycloaliphatic monomer M2 is selected from cycloalkyl (meth)acrylate, preferably from cyclo-C₅-C₇-alkyl (meth)acrylate, in particular from cyclohexyl (meth)acrylate.
25. Process according to any one of embodiments 21 to 24, wherein the at least one unsaturated aromatic monomer M3 is selected from styrene.
26. Process according to any one of embodiments 21 to 25, wherein the at least one unsaturated hydroxy-group containing monomer M4 is selected from hydroxyl group-containing (meth)acrylates, more preferably from hydroxy C₁-C₁₂ alkyl group-containing (meth)acrylates, even more preferably selected from 2-hydroxyethyl (meth)acrylate, 2-hydroxyisopropyl (meth)acrylate, 3-hydroxypropyl (meth)acrylate, hydroxyisobutyl (meth)acrylate and 4-hydroxybutyl (meth)acrylate, very preferably from 2-hydroxyethyl (meth)acrylate and 3-hydroxypropyl (meth)acrylate.
27. Process according to any one of embodiments 18 to 26, wherein the at least one binder is present in each provided coating composition in a total amount of 10 to 70 wt.-%, preferably of 20 to 60 wt.-%, more preferably 25 to 55 wt.-%, very preferably of 30 to 45 wt.-%, based in each case on the total weight of the provided coating composition.
28. Process according to any one of the preceding embodiments, wherein the specific leveling properties and/or the specific sag resistance of the provided coating compositions are achieved by the presence of at least one sagging control agent (SCA) in at least one provided coating composition.
29. Process according to embodiment 28, wherein the sagging control agent (SCA) is selected from polymeric sagging control agents.
30. Process according to embodiment 29, wherein the polymeric sagging control agent (SCA) is obtained by reacting a primary or secondary amine, in particular benzyl amine, with an isocyanate compound, in particular with a polyisocyanate, in the presence of a hydroxy-functional poly(meth)acrylate.
31. Process according to embodiment 30, wherein the hydroxy-functional poly(meth)acrylate contains—in polymerized form—at least one unsaturated monomer comprising at least one acid group M1, at least one unsaturated aliphatic monomer M2, at least one unsaturated aromatic monomer M3 and at least one unsaturated hydroxy-group containing monomer M4.
32. Process according to any one of embodiments 29 to 31, wherein the polymeric sagging control agent has an average molecular weight Mw of 3,000 to 50,000 g/mol, preferably of 4,000 to 30,000 g/mol, very preferably of 5,000 to 15,000 g/mol, as determined with GPC using polystyrene as internal standard.
33. Process according to any one of embodiments 30 to 32, wherein the hydroxy-functional poly(meth)acrylate used to prepare the polymeric sagging control agent is present in the provided coating composition comprising no polymeric sagging control agent or comprising lower amounts of polymeric sagging agent as compared to provided coating compositions comprising higher amounts of polymeric sagging agent.
34. Process according to any one of embodiments 28 to 33, wherein the sagging control agent (SCA), in particular the polymeric sagging control agent, is present in a total amount of 0.1 to 40 wt.-%, preferably of 2 to 30 wt.-%, more preferably of 3 to 20 wt.-%, very preferably of 4 to 15 wt.-%, based in each case on the total weight of the respective provided coating composition.
35. Process according to any one of the preceding embodiments, wherein at least one provided coating composition further comprises at least one additive being different from the sagging control agent (SCA).
36. Process according to embodiment 35, wherein the at least one additive being different from the sagging control additive is selected from light stabilizers, leveling agents, UV absorbers, pigments, free-radical scavengers, slip additives, polymerization inhibitors, defoamers, wetting agents, adhesion promoters, flow control agents, film-forming assistants such as cellulose derivatives, fillers, rheology control additives, flame retardants and/or water scavengers, in particular light stabilizers and leveling agents.
37. Process according to embodiment 36, wherein the leveling agents are selected from silicon-containing leveling agents.
38. Process according to any one of the preceding embodiments, wherein the provided coating compositions only differ in the amount and/or type of leveling agent(s) and/or sagging control agent(s) (SCA) and/or solvent(s).
39. Process according to any one of the preceding embodiments, wherein step (b) is performed using a spray application equipment.
40. Process according to any of the preceding claims, wherein the coating composition C₁ and/or each further coating composition Cₓ is applied onto all target areas having the same properties.
41. Process according to any one of the preceding embodiments, wherein provided coating compositions having high leveling properties are each applied onto at least part of the horizontally oriented target areas of the object and wherein provided coating compositions having a high sag resistance are each applied onto at least part of the vertically oriented target areas of the object.
42. Process according to any one of the preceding embodiments, further including a step (e) of curing or drying and curing the applied the coating composition(s).
43. Use of the process according to any one of the preceding embodiments for coating target areas of a substate having different orientations relative to each other.
44. A system for applying—utilizing an application device—at least two coating compositions having different leveling properties and/or a different sag resistance to an object comprising a plurality of target areas, at least part of the plurality of target areas having different properties, the system comprising:
   an application device comprising a nozzle;
   a storage device for storing application instructions and optionally mixing ratio instructions;
   one or more data processors configured to execute the application instructions and optionally the mixing ratio instructions to control the application device; and
   at least two reservoirs in fluid communication with the application device and configured to contain at least two components (Aᵢ)_{i=1, . . . , n}, each component Aᵢ having different leveling properties and/or a different specific sag resistance, and optionally at least one hardener component B or configured to contain at least two coating compositions (Cᵢ)_{i=1, . . . , n} having specific leveling properties and/or a specific sag resistance,
   wherein the application device is configured to
      receive the components (Aᵢ)_{i=1, . . . , n} and optionally the hardener component B from the reservoir and to mix the components (Aᵢ)_{i=1, . . . , n}, optionally with the hardener component B based on the mixing ratio instructions within the nozzle, and
      to expel the resulting coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object; or
   wherein the applicator is configured to
      receive the at least two coating compositions (Cᵢ)_{i=1, . . . , n} from the reservoir, and
      to expel the coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object.
45. The system according to claim 44, wherein the one or more data processors are further configured to generate the application instructions by:
   receiving, by the one or more data processors, target image data of the object, the target image data including the different target areas,
   generating, based on the received image data, the application instructions.

### DESCRIPTION OF THE DRAWINGS

FIG. 1 shows a schematical drawing of a vehicle 100 to be coated with a coating material. In this example, the coating material is a clearcoat material. In another example, the coating material is a primer coating material, a primer-surfacer coating material, a filler coating material or a basecoat material. The vehicle 100 contains horizontally oriented areas 102 to be coated as well as vertically oriented areas 104 to be coated. Using the inventive process to coat the horizontally oriented areas 102 and the vertically oriented areas 104 with coating materials, a coating material having a high sag resistance is applied on the vertically oriented areas 104 whereas a coating material having good leveling properties and low sag resistance is applied on the horizontally oriented area 102. The coating material having a high sag resistance is obtained, for example, by using a component Aᵢ containing a sagging control additive (SCA), such as the coating composition CC1 disclosed in relation to the inventive examples. The coating material having high leveling properties and a low sag resistance is obtained by mixing at least two components Aᵢ, Aᵢ₊₁ in a defined mixing ratio, wherein one component Aᵢ or Aᵢ₊₁ contains a sagging control additive (SCA), and the other component Aᵢ₊₁ or Aᵢ does not contain a sagging control additive (SCA) such that the resulting coating material contains a lower concentration of sagging control additive as compared to the component Aᵢ or Aᵢ₊₁ containing the sagging control additive (SCA).

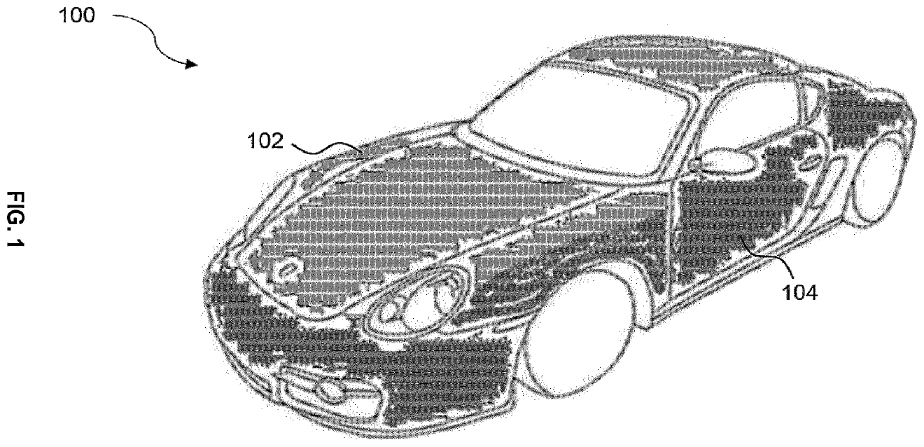

### EXAMPLES

The present invention will now be explained in greater detail using working examples, but the present invention is in no way limited to these working examples. Moreover, the terms “parts”, “%” and “ratio” in the examples denote “parts by mass”, “mass %” and “mass ratio” respectively unless otherwise indicated.

### A) Methods of Determination

### 1. Solids Content (Solids, Nonvolatile Fraction)

Unless otherwise indicated, the solids content, also referred to as solid fraction hereinafter, was determined in accordance with DIN EN ISO 3251:2008-06 at 130° C. and 60 min, initial mass 1.0 g.

### 2. Sag Resistance on Vertically Oriented Areas

Determination of sag resistance on vertically oriented areas was done through an application of the coating material in a wedge with a layer thickness from 10 to 50 μm onto panels primed with an electrodeposited coating and coated with a basecoat. The basecoat was cured before application of the clearcoat formulation. Sagging occurred on holes in the panels, imitating edges in a car body. Measurand for sagging was the layer thickness, at which sagging length reached 3 mm and 10 mm length.

In more detail, a perforated steel panel having dimensions of 57 cm×20 cm (according to DIN EN ISO 28199-1, section 8.1, version A), coated with a cured cathodic electrodeposition paint (Cathoguard® 800 from BASF Coatings GmbH) and with a cured commercially available water-based basecoat material (ColorBrite from BASF Coatings GmbH) was prepared analogously to DIN EN ISO 28199-1, section 8.2 (version A). The clearcoat material was then electrostatically applied in the form of wedges with a target film thickness (film thickness of the dried material) of 10 μm to 50 μm in a single application in a method based on DIN EN ISO28199-1, section 8.3. After a flash time of 10 minutes at room temperature (25° C.), the resulting clear coating film was cured in a forced air oven at 140° C. for 20 minutes. The steel panels were flashed and cured while standing upright.

The sag resistance was determined in each case according to DIN EN ISO 28199-3, section 4. Measurand for sag resistance was the layer thickness at which the sagging length reached 3 mm and 10 mm length.

### 3. Measurement of DOI

The DOI was evaluated at a dry film thickness of 30 to 35 micrometer using a model D 47-6 DOI meter from Hunter Dorigon of Fairfax, Va., per ASTM D-5767-18 after preparing the coating as described below.

### 4. Wavescan Measurements

Wavescan measurements were performed at a dry film thickness of 30 to 35 micrometer on a Wave-scan Plus 4806 meter from BYK Gardner, per GM4364M after preparing the coating as described below. The shortwave and longwave values are the average of three readings.

### 5. Overspray Compatibility

The overspray compatibility of different clearcoat compositions was determined as follows:

A steel panel coated with a cured cathodic electrodeposition paint (Cathoguard® 800 from BASF Coatings GmbH) and with a cured commercially available water-based basecoat material (ColorBrite from BASF Coatings GmbH) was electrostatically coated with the first clearcoat composition in a target film thickness (film thickness of the dried material) of 40 μm±5 μm in a single application. Afterwards, half of the panel was manually coated with the second clearcoat composition in a single slow hit with an assumed target film thickness (film thickness of the dried material) of ˜10 μm. After a flash time of 10 minutes at room temperature (25° C.), the resulting clear coating films were cured in a forced air oven at 140° C. for 20 minutes.

The resulting panel is visually evaluated for surface defects like e.g. matte/dull areas. If the clearcoat layers are visually ok and glossy, the panel is rated i.O. (Okay). Otherwise, the panel is rated n.i.O. (not okay).

### B) Preparation of Different Clearcoat Coating Compositions

### 1. Preparation of Components Provided in Step (a) of the Inventive Process

Each component A1 and A2 was prepared by mixing the components given in Table 1. Component A1 contains a high amount of sagging control agent (SCA) while component A2 does not contain a sagging control agent. Solvent naphtha is used in component A2 to compensate the residual amount such that each component A1 and A2 equals to 100.

TABLE 1
Ingredients to prepare the component A1 and A2
(all amounts are given in % by weight)

| Ingredients | A1 | A2 |
|---|---|---|
| (Meth)acrylic resin 1 ¹⁾ | 47.7 | 47.7 |
| Polymeric sagging additive ²⁾ | 17 | — |
| (Meth)acrylic resin 2 ³⁾ | — | 15.4 |
| Solventnaphtha 160/180 | — | 1.56 |
| SETAMINE US-138 BB-70 ⁴⁾ | 9.0 | 9.0 |
| CYMEL 303 LF Resin ⁵⁾ | 1.9 | 1.9 |
| Setal ® 1715 ⁶⁾ | 4.9 | 4.9 |
| UV-Absorber 1130 ⁷⁾ | 1.29 | 1.3 |
| HALS 292 ⁸⁾ | 0.97 | 0.97 |
| BYK-325 N ⁹⁾ | 0.20 | 0.20 |
| BYK 315 N ¹⁰⁾ | 0.03 | 0.03 |
| Butylglycol acetate | 1.0 | 1.0 |
| Xylene | 0.97 | 0.97 |
| Flowlen AC 300 ¹¹⁾ | 0.04 | 0.04 |
| Xylene | 3.6 | 3.6 |
| Butylglycol acetate | 4.8 | 4.8 |
| Butyldiglycol acetate | 0.8 | 0.8 |
| Butanol | 5.8 | 5.8 |

¹⁾ the hydroxy-functional (meth)acrylic resin contains the following monomers: styrene, hydroxyethyl methacrylate, hydroxypropyl methacrylate, butyl methacrylate, cyclohexyl methacrylate and acrylic acid, solids content = 56%,
²⁾ prepared according to the procedure described under “Herstellung eines erfindungsgemäßen SCA Harzes” on page 18, lines 5 to 26 of WO2008148555A1,
³⁾ prepared according to the procedure described under “Herstellung eines erfindungsgemäßen SCA Harzes” on page 18, lines 5 to 17 of WO2008148555A1,
⁴⁾ n-butylated high imino melamine crosslinker, solids content = 68-72% (supplied by Allnex);
⁵⁾ highly methylated, monomeric melamine crosslinker, solids content = ≥98% (supplied by Allnex);
⁶⁾ saturated polyester having an OH content of 4.4%, based on solids, a solids content of 71-73%, an acid number of from 6.5 to 9.8, a viscosity from 4.0 to 5.8 Pas at 23° C. and 100 s⁻¹ (supplied by Allnex);
⁷⁾ liquid UV absorber of the hydroxyphenyl benzotriazole class (supplied by BASF Dispersions & Resins);
⁸⁾ liquid hindered amine light stabilizer (Tinuvin ® 292) (supplied by BASF Dispersions & Resins);
⁹⁾ polyether-modified polymethylalkylsiloxane, solid content = 52% (supplied by BYK-Chemie GmbH);
¹⁰⁾ polyester-modified polymethylalkylsiloxane, solid content = 25% (supplied by BYK-Chemie GmbH);
¹¹⁾ Acrylic polymer/polyvinylether, solid content = 77% (supplied by Kyoeisha Chemical)

### 2. Preparation of the Hardener Component

The hardener component B was prepared by mixing the components given in Table 2:

TABLE 2
Ingredients to prepare the hardener component B

| Ingredients | Amount [wt.-%] |
|---|---|
| Polyisocyanate ¹⁾ | 89.6 |
| Solventnaphtha 160/180 | 5.2 |
| Butylacetate | 5.2 |

¹⁾ Desmodur Ultra N 3390 BA/SN, solid content = 90% (supplied by Covestro AG)

### 3 Preparation of Different Clearcoat Coating Compositions

The clearcoat compositions CC1 to CC3 were each prepared by mixing the respective component A1 and A2 or a mixture of components A1 and A2 with the hardener component B in the mixing ratios given in Table 3.

TABLE 3
Clearcoat composition CC1 to CC3

| Clearcoat | Component | Mixing ratio | Mixing ratio |
|---|---|---|---|
| compositions | (a) | A1:A2 | (a):B |
| CC1 | A1 | — | 100:33 |
| CC2 | A1 and A2 | 1.1 | 100:33 |
| CC3 | A2 | — | 100:33 |

### C) Preparation of Coated Objects

### 1. Preparation of Coated Substates for Evaluation of Sag Resistance:

Test panels for evaluation of sag resistance were prepared as described in point A) 2. above.

### 2. Preparation of Coated Objects for Evaluation of Horizontal Appearance

Test panels for the evaluation of horizontal appearance were prepared by coating steel panels coated with a cured cathodic electrodeposition paint (Cathoguard® 800 from BASF Coatings GmbH) and with a cured commercially available black basecoat material (ColorBrite from BASF Coatings GmbH) with the respective clearcoat composition CC1 to CC3 in a wedge application of 0 μm to 60 μm using ESTA HR Application. After a flash time of 10 minutes at room temperature (25° C.), the resulting clear coating film was cured in a forced air oven at 140° C. for 20 minutes.

### 3. Preparation of Coated Objects for Evaluation of Overspray Compatibility

Test panels for the evaluation of overspray compatibility were prepared as described in point A) 5. above.

### D) Results

### 1. Sag Resistance

The sag resistance of clearcoat compositions CC1 to CC3 was determined as previously described. The obtained results are listed in Table 4. In the upper half of this table, only the differences with regard to the ingredients clearcoats CC1 to CC3 are listed. The footnotes 1) to 3) are corresponding to footnotes 1) to 3) of Table 1.

TABLE 4
Results of sag resistance for clearcoats CC1 to CC3

| Ingredient | CC1 | CC2 | CC3 |
|---|---|---|---|
| (Meth)acrylic resin 1 ¹⁾ | 47.7 | 47.7 | 47.7 |
| Polymeric sagging additive ²⁾ | 17 | 8.5 | — |
| (Meth)acrylic resin 2 ³⁾ | — | 7.7 | 15.4 |
| Solventnaphtha 160/180 | — | 0.78 | 1.56 |
| Sagging start [μm] | 37 | 29 | 31 |
| 3 mm Sagging length [μm] | 47 | 43 | 44 |
| 10 mm Sagging length [μm] | 59 | 50 | 48 |

### 2. Leveling Properties

The leveling properties of clearcoat compositions CC1 to CC3 was determined as previously described. The obtained results are listed in Table 5. In the upper half of this table, only the differences with regard to the ingredients clearcoats CC1 to CC3 are listed. The footnotes 1) to 3) are corresponding to footnotes 1) to 3) of Table 1.

TABLE 5
Leveling properties for clearcoats CC1 to CC3

| Ingredient | CC1 | CC2 | CC3 |
|---|---|---|---|
| (Meth)acrylic resin 1 ¹⁾ | 47.7 | 47.7 | 47.7 |
| Polymeric sagging additive ²⁾ | 17 | 8.5 | — |
| (Meth)acrylic resin 2 ³⁾ | — | 7.7 | 15.4 |
| Solventnaphtha 160/180 | — | 0.78 | 1.56 |
| Longwave values [30-35 μm] | 8.9 | 5.5 | 5.4 |
| Shortwave values [30-35 μm] | 8.7 | 8.6 | 8 |
| DOI [30-35 μm] | 96.2 | 96.2 | 96.1 |

### 3. Overspray Compatibility

The overspray compatibility of clearcoat compositions CC1 to CC3 was determined as previously described. The obtained results are listed in Tables 6 and 7. In the upper half of this table, only the differences with regard to the ingredients clearcoats CC1 to CC3 are listed. The footnotes 1) to 3) are corresponding to footnotes 1) to 3) of Table 1.

TABLE 6
Overspray compatibility for clearcoats CC1 to CC3
on horizontally oriented object

| | | First layer on horizontal object | | |
|---|---|---|---|---|
| | Ingredient | CC1 | CC2 | CC3 |
| | (Meth)acrylic resin 1 ¹⁾ | 47.7 | 47.7 | 47.7 |
| | Polymeric sagging | 17 | 8.5 | — |
| | additive ²⁾ | | | |
| | (Meth)acrylic resin 2 ³⁾ | — | 7.7 | 15.4 |
| | Solventnaphtha 160/180 | — | 0.78 | 1.56 |
| Overspray | CC1 | — | Not OK | Not OK |
| horizontal | CC2 | OK | — | Not OK |
| | CC3 | Not OK | OK | — |

TABLE 7
Overspray compatibility for clearcoats CC1 to CC3
on vertical oriented object

| | | First layer on vertical object | | |
|---|---|---|---|---|
| | Ingredient | CC1 | CC2 | CC3 |
| | (Meth)acrylic resin 1 ¹⁾ | 47.7 | 47.7 | 47.7 |
| | Polymeric sagging | 17 | 8.5 | — |
| | additive ²⁾ | | | |
| | (Meth)acrylic resin 2 ³⁾ | — | 7.7 | 15.4 |
| | Solventnaphtha 160/180 | — | 0.78 | 1.56 |
| Overspray | CC1 | — | Not OK | Not OK |
| vertical | CC2 | OK | — | Not OK |
| | CC3 | Not OK | OK | — |

### E) Discussion of the Results

The highest sag resistance on vertically oriented objects is obtained for clearcoat composition CC1 containing high amounts of sagging control agent (SCA) (see Table 4). By mixing component A1 containing high amounts of sagging control agent (SCA) with component A2 being free of sagging control agents (SCAs), the sagging resistance on vertically oriented objects was significantly reduced. This is due to the reduced amount of sagging control agent.

However, the leveling properties of the clearcoat composition CC2 on horizontally oriented objects was significantly improved by mixing SCA-containing component A1 with SCA-free component A2 and the obtained clearcoat composition CC2 even has better leveling properties than the SCA-free clearcoat composition CC3 (see Table 5). Thus, by selecting an appropriate mixing ratio in step (b) of the inventive process, the leveling properties and sag resistance of the clearcoat compositions can be adjusted to achieve either high sag resistance for vertically oriented objects or good leveling properties for horizontally oriented objects. Since the mixing ratio can be dynamically adjusted in step (b) if, for example, an application nozzle (such as the EcoBell 3 2X2K manufactured by company Dürr) allowing attachment of 3 reservoirs containing component A1, A2 and hardener B is used, objects containing horizontally as well as vertically oriented surfaces can be coated in a high quality because the sag resistance and leveling properties can be adjusted depending on the orientation of the surface during application of the clearcoat composition. The high compatibility upon mixing of the components A1 and A2 is achieved by using the same binder in component A2 which is used to prepare the sagging control agent to compensate the absence of the SCA. Moreover, components A1 and A2 only differ in the presence of the SCA while all other ingredients and their amounts are kept constant to avoid an undesired negative influence on the quality of the resulting clearcoat layer due to incompatibilities occurring upon mixing of the components A1 and A2.

To achieve a high optical quality without a negative influence due to incompatibilities of the different clearcoat compositions, the clearcoat compositions have to be applied in a defined order, as is demonstrated by the overspray compatibility studies. According to the results demonstrated in Tables 6 and 7, a high compatibility (i.e. no negative influence on the optical quality of the resulting clearcoat layer achieved by applying clearcoat composition CC1 as well as CC2) is achieved if clearcoat composition CC1 is first applied on vertically oriented objects and afterwards, clearcoat composition CC2 is applied on horizontally oriented objects.

1. A process for applying at least two coating compositions having different leveling properties and/or a different sag resistance to an object comprising a plurality of target areas, at least part of the plurality of target areas having different properties, said process comprising:
(a) providing a first coating composition C₁ having specific leveling properties and/or a specific sag resistance,
(b) applying the first coating composition C₁ provided in step (a) onto at least part of the plurality of target areas having first properties P₁, and
(c) repeating steps (a) and (b) at least once, wherein
the specific leveling properties and/or a specific sag resistance of each further coating composition Cₓ provided upon repeating step (a) differ from the specific leveling properties and/or the specific sag resistance of the previously provided coating composition C₁ and each previously provided further coating composition Cₓ, and
each coating composition Cₓ is applied onto at least part of the plurality of target areas having properties being different from the properties P₁ and the properties of each further previously coated target areas upon repeating (b).

2. The process according to claim 1, wherein step (a) includes
(a-1) providing at least two components (Aᵢ)_{i=1, . . . , n} having different leveling properties and/or a different sag resistance and optionally at least one hardener component B,
(a-2) selecting mixing ratio(s) for at least part of the components Aᵢ provided in step (a-1) to achieve specific leveling properties and/or a specific sag resistance of the first coating composition C₁ and/or further coating composition(s) Cₓ,
(a-3) optionally selecting mixing ratio(s) for the at least one hardener component B provided in step (a-1), and
(a-4) mixing components Aᵢ, optionally with the at least one hardener component B in the mixing ratio(s) selected in step (a-2) and optionally (a-3) to provide the coating composition C₁ and/or further coating composition(s) Cₓ specific leveling properties and/or a specific sag resistance.

3. The process according to claim 2, wherein step (a-2) includes determining the required specific leveling properties and/or sag resistance of the first coating composition C₁ and/or further coating composition(s) Cₓ and selecting a mixing ratio for at least part of the components provided in step (a-1) such that the specific leveling properties and/or the specific sag resistance of the resulting first coating composition C₁ and/or further coating composition(s) Cₓ is achieved.

4. The process according to claim 3, wherein a higher fraction of components provided in step (a-1) and having a high sag resistance is selected in step (a-2) if a higher sag resistance of the coating composition C₁ and/or further coating composition(s) Cₓ is required or wherein a lower fraction of components provided in step (a-1) and having a high sag resistance is selected in step (a-2) if higher leveling properties of the first coating composition C₁ and/or further coating composition(s) Cₓ are required.

5. The process according to claim 1, wherein step (a) includes preparing the first coating composition C₁ and/or further coating composition(s) Cₓ having specific leveling properties and/or a specific sag resistance by mixing at least two coating material ingredients.

6. The process according to claim 1, wherein the different properties include different orientations of at least two target areas relative to each other.

7. The process according to claim 1, wherein at least one provided coating composition has good leveling properties and at least one further provided coating composition has a good sag resistance.

8. The process according to claim 1, wherein the different leveling properties and/or the different sag resistance of the provided coating compositions are achieved by the presence of at least one sagging control agent (SCA) in at least one provided coating composition.

9. The process according to claim 8, wherein the sagging control agent (SCA) is selected from the group consisting of polymeric sagging control agents.

10. The process according to claim 9, wherein the polymeric sagging control agent (SCA) is obtained by reacting a primary or secondary amine with an isocyanate compound in the presence of a hydroxy-functional poly(meth)acrylate.

11. The process according to claim 7, wherein the sagging control agent (SCA) is present in a total amount of 0.1 to 40 wt.-% based on the total weight of the respective provided coating composition.

12. The process according to claim 1, wherein provided coating compositions having high leveling properties are each applied onto at least part of the horizontally oriented target areas of the object and wherein provided coating compositions having a high sag resistance are each applied onto at least part of the vertically oriented target areas of the object.

13. The process according to claim 1, further including a step (e) of curing or drying and curing the applied the coating composition(s).

14. A method of using the process according to claim 1, the method comprising using the process for coating target areas of a substate having different orientations relative to each other.

15. A system for applying—utilizing an application device—at least two coating compositions having different leveling properties and/or a different sag resistance to an object comprising a plurality of target areas, at least part of the plurality of target areas having different properties, the system comprising:
an application device comprising a nozzle;
a storage device for storing application instructions and optionally mixing ratio instructions;
one or more data processors configured to execute the application instructions and optionally the mixing ratio instructions to control the application device; and
at least two reservoirs in fluid communication with the application device and configured to contain at least two components (Aᵢ)_{i=1, . . . , n}, each component Aᵢ having different leveling properties and/or a different specific sag resistance, and optionally at least one hardener component B or configured to contain at least two coating compositions (Cᵢ)_{i=1, . . . , n} having specific leveling properties and/or a specific sag resistance,
wherein the application device is configured to
receive the components (Aᵢ)_{i=1, . . . , n} and optionally the hardener component B from the reservoir and to mix the components (Aᵢ)_{i=1, . . . , n}, optionally with the hardener component B based on the mixing ratio instructions within the nozzle, and
to expel the resulting coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object; or
wherein the applicator is configured to
receive the at least two coating compositions (Cᵢ)_{i=1, . . . , n} from the reservoir, and
to expel the coating compositions (Cᵢ)_{i=1, . . . , n} based on the application instruction through the nozzle to at least two target areas having different properties to form at least two coating layers such that at least part of each coating composition Cᵢ is not expelled to the same target area(s) of the object.

16. The process according to claim 9, wherein the polymeric sagging control agent (SCA) is obtained by reacting a benzyl amine, with an isocyanate compound in the presence of a hydroxy-functional poly(meth)acrylate.

17. The process according to claim 9, wherein the polymeric sagging control agent (SCA) is obtained by reacting a primary or secondary amine with a polyisocyanate in the presence of a hydroxy-functional poly(meth)acrylate.

18. The process according to claim 7, wherein the sagging control agent (SCA) is present in a total amount of 2 to 30 wt.-% based on the total weight of the respective provided coating composition.

19. The process according to claim 7, wherein the sagging control agent (SCA) is present in a total amount of 3 to 20 wt.-% based on the total weight of the respective provided coating composition.

20. The process according to claim 7, wherein the sagging control agent (SCA) is present in a total amount of 4 to 15 wt.-% based on the total weight of the respective provided coating composition.
